(19) United States
(12) Patent Application Publication
(10) Pub. No.: US 2014/0368537 A1
(43) Pub. Date: Dec. 18, 2014

(54) SHARED AND PRIVATE HOLOGRAPHIC OBJECTS

(71) Applicants: Tom G. Salter, Seattle, WA (US); Ben J. Sugden, Woodinville, WA (US); Daniel Deptford, Redmond, WA (US); Robert L. Crocco, JR., Seattle, WA (US); Brian E. Keane, Bellevue, WA (US); Laura K. Massey, Redmond, WA (US); Alex Aben-Athar Kipman, Redmond, WA (US); Peter Tobias Kinnebrew, Seattle, WA (US); Nicholas Ferianc Kamuda, Seattle, WA (US)

(72) Inventors: Tom G. Salter, Seattle, WA (US); Ben J. Sugden, Woodinville, WA (US); Daniel Deptford, Redmond, WA (US); Robert L. Crocco, JR., Seattle, WA (US); Brian E. Keane, Bellevue, WA (US); Laura K. Massey, Redmond, WA (US); Alex Aben-Athar Kipman, Redmond, WA (US); Peter Tobias Kinnebrew, Seattle, WA (US); Nicholas Ferianc Kamuda, Seattle, WA (US)

(21) Appl. No.: 13/921,122

(22) Filed: Jun. 18, 2013

(51) Int. Cl. G06T 19/00

(52) U.S. Cl. CPC G06T 19/006
USPC 345/633

(57) ABSTRACT

A system and method are disclosed for displaying virtual objects in a mixed reality environment including shared virtual objects and private virtual objects. Multiple users can collaborate together in interacting with the shared virtual objects. A private virtual object may be visible to a single user. In examples, private virtual objects of respective users may facilitate the users' collaborative interaction with one or more shared virtual objects.

### BACKGROUND

Mixed reality is a technology that allows holographic, or virtual, imagery to be mixed with a real world physical environment. A see-through, head mounted, mixed reality display device may be worn by a user to view the mixed imagery of real objects and virtual objects displayed in the user's field of view. A user may further interact with virtual objects, for example by performing hand, head or voice gestures to move the objects, alter their appearance or simply view them. Where there are multiple users, each may view a virtual object in the scene from their own perspective. However, where virtual objects are interactive in some way, multiple users interacting concurrently may make the system cumbersome to use.

### SUMMARY

Embodiments of the present technology relate to a system and method for multi-user interaction with virtual objects, also referred to herein as holograms. A system for creating a mixed reality environment in general includes a see-through, head mounted display device worn by each user and coupled to one or more processing units. The processing units in cooperation with the head mounted display unit(s) are able to display virtual objects, viewable by each user from their own perspective. The processing units in cooperation with the head mounted display unit(s) are also able to detect user interaction with virtual objects via gestures performed by one or more users.

In accordance with aspects of the present technology, certain virtual objects may be designated as shared, so that multiple users can view those shared virtual objects and multiple users can collaborate together in interacting with the shared virtual objects. Other virtual objects may be designated as private to a particular user. A private virtual object may be visible to a single user. In embodiments, private virtual objects may be provided for a variety of purposes, but private virtual objects of respective users may facilitate the users' collaborative interaction with one or more shared virtual objects.

In an example, the present technology relates to a system for presenting a mixed reality experience, the system comprising: a first display device including a display unit for displaying virtual objects including a shared virtual object and a private virtual object; and a computing system operatively coupled to the first display device and a second display device, the computing system generating the shared and private virtual objects for display on the first display device, and the computing system generating the shared but not the private virtual object for display on a second display device.

In a further example, the present technology relates to a system for presenting a mixed reality experience, the system comprising: a first display device including a display unit for displaying virtual objects; a second display device including a display unit for displaying virtual objects; and a computing system operatively coupled to the first and second display devices, the computing system generating a shared virtual object for display on the first and second display devices from state data defining the shared virtual object, the computing system further generating a first private virtual object for display on the first display device and not the second display device, and a second private virtual object for display on the second display device and not the first display device, the computing system receiving an interaction changing the state data and the display of the shared virtual object on both the first and second display devices.

In another example, the present technology relates to a method for presenting a mixed reality experience, the method comprising: (a) displaying a shared virtual object to a first display device and a second display device, the shared virtual object defined by state data that is the same for the first and second display devices; (b) displaying a first private virtual object to the first display device; (c) displaying a second private virtual object to the second display device; (d) receiving an interaction with one of the first and second private virtual objects; and (e) affecting a change in the shared virtual object based on the interaction with one of the first and second private virtual objects received in said step (d).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of example components of one embodiment of a system for presenting a mixed reality environment to one or more users.

FIG. 2 is a perspective view of one embodiment of a head mounted display unit.

FIG. 3 is a side view of a portion of one embodiment of a head mounted display unit.

FIG. 4 is a block diagram of one embodiment of the components of a head mounted display unit.

FIG. 5 is a block diagram of one embodiment of the components of a processing unit associated with a head mounted display unit.

FIG. 6 is a block diagram of one embodiment of the components of a hub computing system used with head mounted display unit.

FIG. 7 is a block diagram of one embodiment of a computing system that can be used to implement the hub computing system described herein.

FIGS. 8-13 are illustrations of an example of a mixed reality environment including shared virtual objects and private virtual objects.

FIG. 14 is a flowchart showing the operation and collaboration of the hub computing system, one or more processing units and one or more head mounted display units of the present system.

FIGS. 15-17 are more detailed flowcharts of examples of various steps shown in the flowchart of FIG. 14.

### DETAILED DESCRIPTION

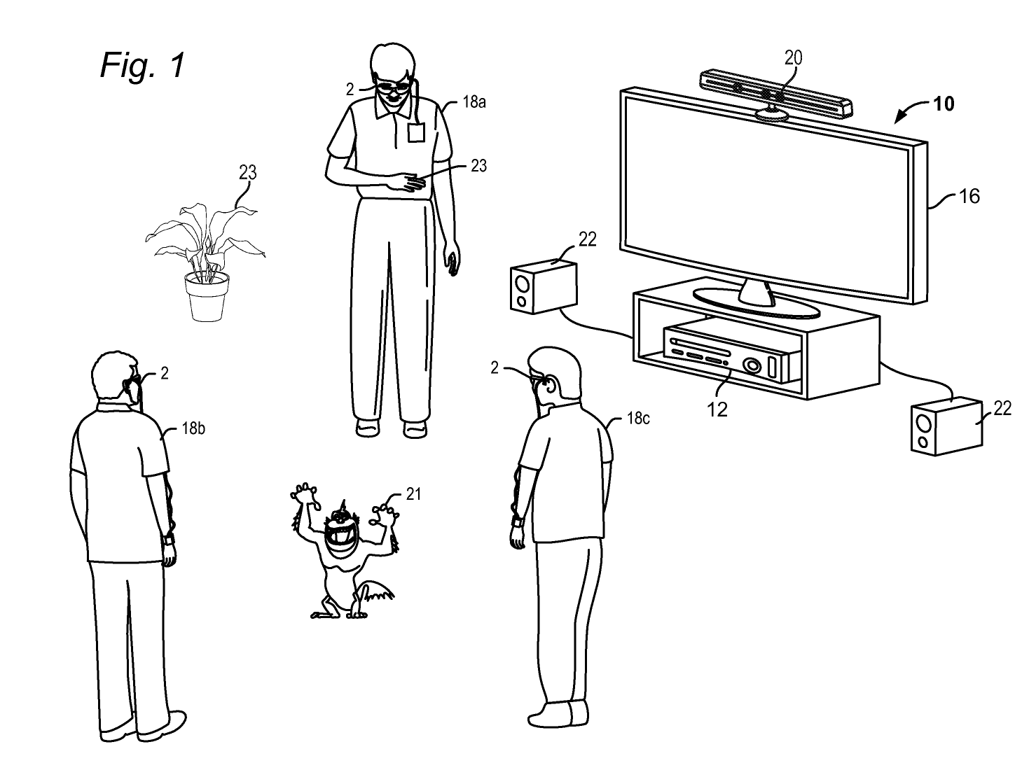

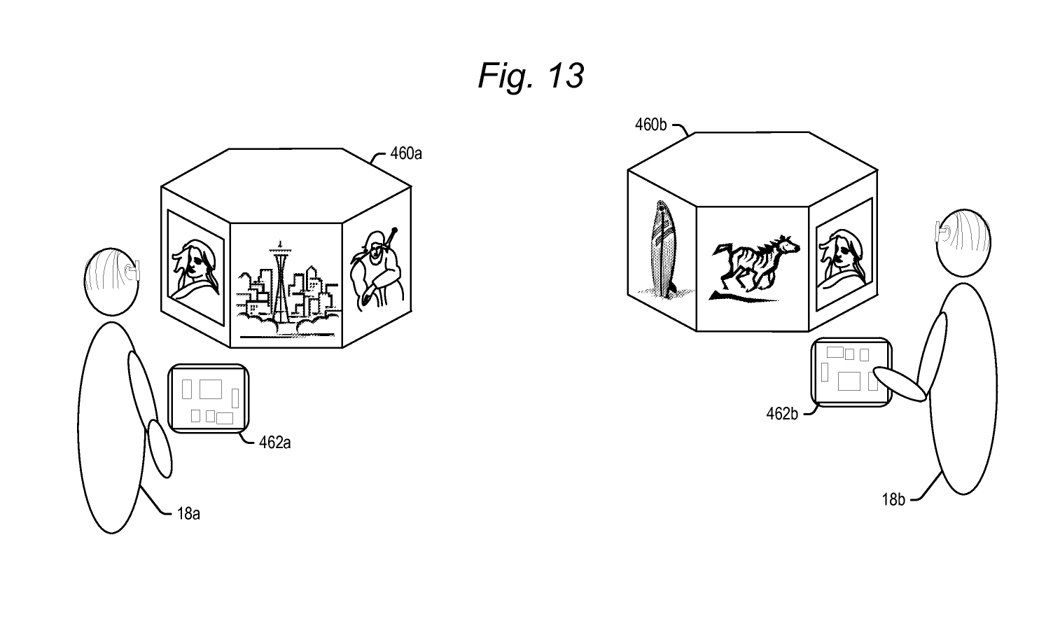

Embodiments of the present technology will now be described with reference to FIGS. 1-17, which in general relate to a mixed reality environment including collaborative shared virtual objects and private virtual objects which may be interacted with to facilitate collaboration on the shared virtual objects. The system for implementing the mixed reality environment may include a mobile display device communicating with a hub computing system. The mobile display device may include a mobile processing unit coupled to a head mounted display device (or other suitable apparatus).

A head mounted display device may include a display element. The display element is to a degree transparent so that a user can look through the display element at real world objects within the user's field of view (FOV). The display element also provides the ability to project virtual images into the FOV of the user such that the virtual images may also appear alongside the real world objects. The system automatically tracks where the user is looking so that the system can determine where to insert the virtual image in the FOV of the user. Once the system knows where to project the virtual image, the image is projected using the display element.

In embodiments, the hub computing system and one or more of the processing units may cooperate to build a model of the environment including the x, y, z Cartesian positions of all users, real world objects and virtual three-dimensional objects in the room or other environment. The positions of each head mounted display device worn by the users in the environment may be calibrated to the model of the environment and to each other. This allows the system to determine each user's line of sight and FOV of the environment. Thus, a virtual image may be displayed to each user, but the system determines the display of the virtual image from each user's perspective, adjusting the virtual image for parallax and any occlusions from or by other objects in the environment. The model of the environment, referred to herein as a scene map, as well as all tracking of the user's FOV and objects in the environment may be generated by the hub and mobile processing unit working in tandem or individually.

As explained below, one or more users may choose to interact with shared or private virtual objects appearing within the user's FOV. As used herein, the term “interact” encompasses both physical interaction and verbal interaction of a user with a virtual object. Physical interaction includes a user performing a predefined gesture using his or her fingers, hand, head and/or other body part(s) recognized by the mixed reality system as a user-request for the system to perform a predefined action. Such predefined gestures may include but are not limited to pointing at, grabbing, and pushing virtual objects. Such predefined gestures may further include interaction with a virtual control object such as a virtual remote control or keyboard.

A user may also physically interact with a virtual object with his or her eyes. In some instances, eye gaze data identifies where a user is focusing in the FOV, and can thus identify that a user is looking at a particular virtual object. Sustained eye gaze, or a blink or blink sequence, may thus be a physical interaction whereby a user selects one or more virtual objects.

As used herein, a user simply looking at a virtual object, such as viewing content in a shared virtual object, is a further example of physical interaction of a user with a virtual object.

A user may alternatively or additionally interact with virtual objects using verbal gestures, such as for example a spoken word or phrase recognized by the mixed reality system as a user request for the system to perform a predefined action. Verbal gestures may be used in conjunction with physical gestures to interact with one or more virtual objects in the mixed reality environment.

As a user moves around within a mixed reality environment, virtual objects may remain world locked or body locked. World locked virtual objects are those that remain in a fixed position in Cartesian space. Users may move nearer to, farther from or around such world locked virtual objects and view them from different perspectives. In embodiments, shared virtual objects may be world locked.

On the other hand, body locked virtual objects are those that move with a particular user. As one example, body locked virtual objects may remain in a fixed position with respect to a user's head. In embodiments, private virtual object may be body locked. In further examples, virtual objects such private virtual objects may be a hybrid world locked/body locked virtual object. Such hybrid virtual objects are described for example in U.S. patent application Ser. No. 13/921,116 entitled “Hybrid World/Body Locked HUD on an HMD,” filed Jun. 18, 2013.

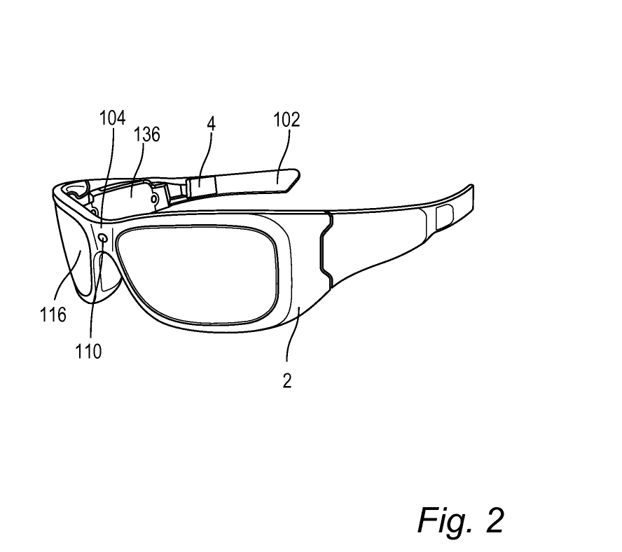

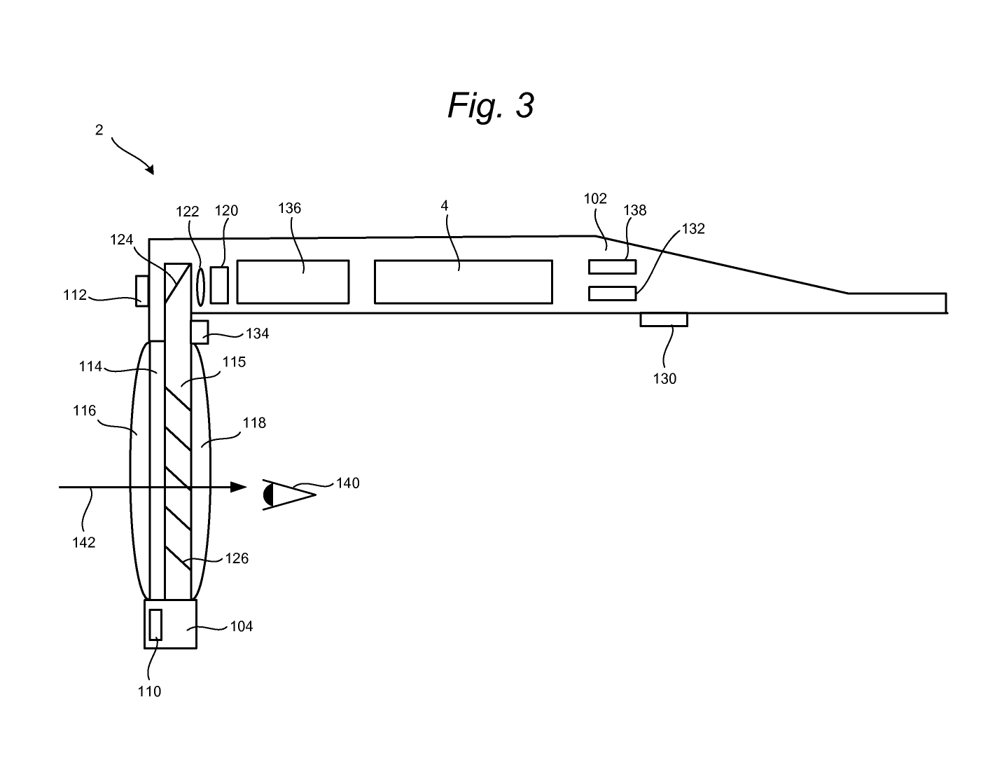

FIG. 1 illustrates a system 10 for providing a mixed reality experience by fusing virtual object 21 with real content within a user's FOV. FIG. 1 shows a multiple users 18a, 18b, 18c, each wearing a head mounted display device 2 for viewing virtual objects such as virtual object 21 from own perspective. There may be more or less than three users in further examples. As seen in FIGS. 2 and 3, a head mounted display device 2 may include an integrated processing unit 4. In other embodiments, the processing unit 4 may be separate from the head mounted display device 2, and may communicate with the head mounted display device 2 via wired or wireless communication.

Head mounted display device 2, which in one embodiment is in the shape of glasses, is worn on the head of a user so that the user can see through a display and thereby have an actual direct view of the space in front of the user. The use of the term “actual direct view” refers to the ability to see the real world objects directly with the human eye, rather than seeing created image representations of the objects. For example, looking through glass at a room allows a user to have an actual direct view of the room, while viewing a video of a room on a television is not an actual direct view of the room. More details of the head mounted display device 2 are provided below.

The processing unit 4 may include much of the computing power used to operate head mounted display device 2. In embodiments, the processing unit 4 communicates wirelessly (e.g., WiFi, Bluetooth, infra-red, or other wireless communication means) to one or more hub computing systems 12. As explained hereinafter, hub computing system 12 may be provided remotely from the processing unit 4, so that the hub computing system 12 and processing unit 4 communicate via a wireless network such as a LAN or WAN. In further embodiments, the hub computing system 12 may be omitted to provide a mobile mixed reality experience using the head mounted display devices 2 and processing units 4.

Hub computing system 12 may be a computer, a gaming system or console, or the like. According to an example embodiment, the hub computing system 12 may include hardware components and/or software components such that hub computing system 12 may be used to execute applications such as gaming applications, non-gaming applications, or the like. In one embodiment, hub computing system 12 may include a processor such as a standardized processor, a specialized processor, a microprocessor, or the like that may execute instructions stored on a processor readable storage device for performing the processes described herein.

Hub computing system 12 further includes a capture device 20 for capturing image data from portions of a scene within its FOV. As used herein, a scene is the environment in which the users move around, which environment is captured within the FOV of the capture device 20 and/or the FOV of each head mounted display device 2. FIG. 1 shows a single capture device 20, but there may be multiple capture devices in further embodiments which cooperate to collectively capture image data from a scene within the composite FOVs of the multiple capture devices 20. Capture device 20 may include one or more cameras that visually monitor the user 18 and the surrounding space such that gestures and/or movements performed by the user, as well as the structure of the surrounding space, may be captured, analyzed, and tracked to perform one or more controls or actions within the application and/or animate an avatar or on-screen character.

Hub computing system 12 may be connected to an audiovisual device 16 such as a television, a monitor, a high-definition television (HDTV), or the like that may provide game or application visuals. In one example, audiovisual device 16 includes internal speakers. In other embodiments, audiovisual device 16 and hub computing system 12 may be connected to external speakers 22.

The hub computing system 12, together with the head mounted display device 2 and processing unit 4, may provide a mixed reality experience where one or more virtual images, such as virtual object 21 in FIG. 1, may be mixed together with real world objects in a scene. FIG. 1 illustrates examples of a plant 23 or a user's hand 23 as real world objects appearing within the user's FOV.

FIGS. 2 and 3 show perspective and side views of the head mounted display device 2. FIG. 3 shows the right side of head mounted display device 2, including a portion of the device having temple 102 and nose bridge 104. Built into nose bridge 104 is a microphone 110 for recording sounds and transmitting that audio data to processing unit 4, as described below. At the front of head mounted display device 2 is room-facing video camera 112 that can capture video and still images. Those images are transmitted to processing unit 4, as described below.

A portion of the frame of head mounted display device 2 will surround a display (that includes one or more lenses). In order to show the components of head mounted display device 2, a portion of the frame surrounding the display is not depicted. The display includes a light-guide optical element 115, opacity filter 114, see-through lens 116 and see-through lens 118. In one embodiment, opacity filter 114 is behind and aligned with see-through lens 116, light-guide optical element 115 is behind and aligned with opacity filter 114, and see-through lens 118 is behind and aligned with light-guide optical element 115. See-through lenses 116 and 118 are standard lenses used in eye glasses and can be made to any prescription (including no prescription). Light-guide optical element 115 channels artificial light to the eye. More details of opacity filter 114 and light-guide optical element 115 are provided in U.S. Published Patent Application No. 2012/0127284, entitled, “Head-Mounted Display Device Which Provides Surround Video,” which application published on May 24, 2012.

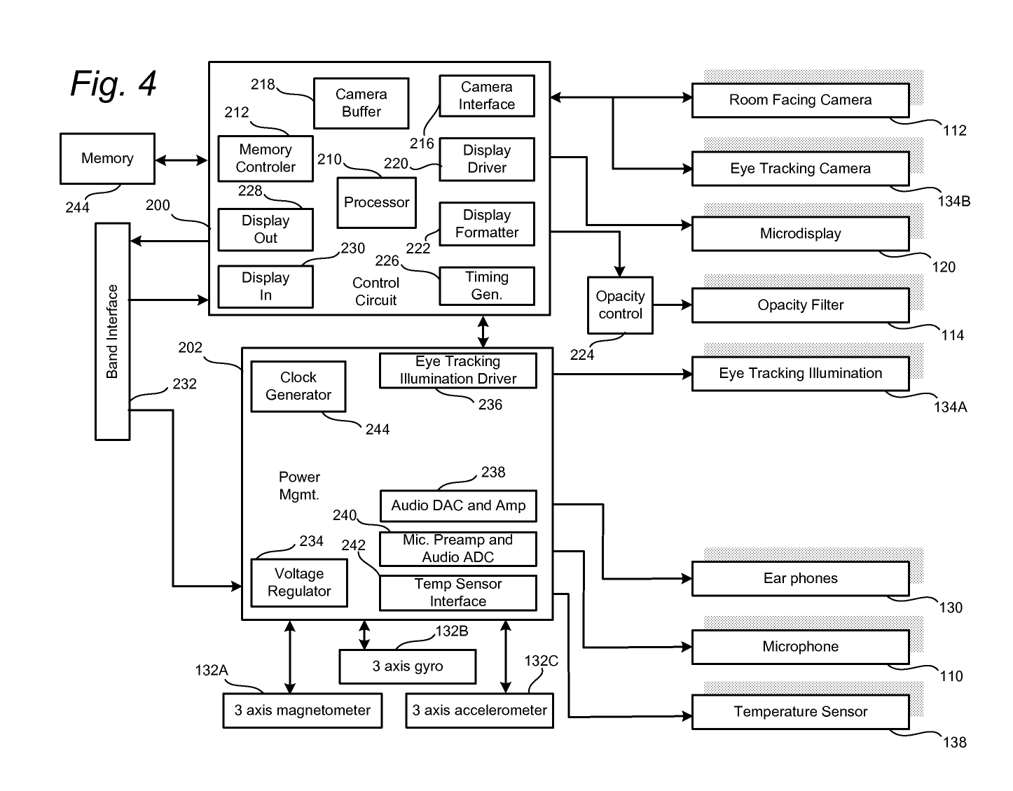

Control circuits 136 provide various electronics that support the other components of head mounted display device 2. More details of control circuits 136 are provided below with respect to FIG. 4. Inside or mounted to temple 102 are ear phones 130, inertial measurement unit 132 and temperature sensor 138. In one embodiment shown in FIG. 4, the inertial measurement unit 132 (or IMU 132) includes inertial sensors such as a three axis magnetometer 132A, three axis gyro 132B and three axis accelerometer 132C. The inertial measurement unit 132 senses position, orientation, and sudden accelerations (pitch, roll and yaw) of head mounted display device 2. The IMU 132 may include other inertial sensors in addition to or instead of magnetometer 132A, gyro 132B and accelerometer 132C.

Microdisplay 120 projects an image through lens 122. There are different image generation technologies that can be used to implement microdisplay 120. For example, microdisplay 120 can be implemented in using a transmissive projection technology where the light source is modulated by optically active material, backlit with white light. These technologies are usually implemented using LCD type displays with powerful backlights and high optical energy densities. Microdisplay 120 can also be implemented using a reflective technology for which external light is reflected and modulated by an optically active material. The illumination is forward lit by either a white source or RGB source, depending on the technology. Digital light processing (DLP), liquid crystal on silicon (LCOS) and Mirasol® display technology from Qualcomm, Inc. are all examples of reflective technologies which are efficient as most energy is reflected away from the modulated structure and may be used in the present system. Additionally, microdisplay 120 can be implemented using an emissive technology where light is generated by the display. For example, a PicoP™ display engine from Microvision, Inc. emits a laser signal with a micro mirror steering either onto a tiny screen that acts as a transmissive element or beamed directly into the eye (e.g., laser).

Light-guide optical element 115 transmits light from microdisplay 120 to the eye 140 of the user wearing head mounted display device 2. Light-guide optical element 115 also allows light from in front of the head mounted display device 2 to be transmitted through light-guide optical element 115 to eye 140, as depicted by arrow 142, thereby allowing the user to have an actual direct view of the space in front of head mounted display device 2 in addition to receiving a virtual image from microdisplay 120. Thus, the walls of light-guide optical element 115 are see-through. Light-guide optical element 115 includes a first reflecting surface 124 (e.g., a mirror or other surface). Light from microdisplay 120 passes through lens 122 and becomes incident on reflecting surface 124. The reflecting surface 124 reflects the incident light from the microdisplay 120 such that light is trapped inside a planar substrate comprising light-guide optical element 115 by internal reflection. After several reflections off the surfaces of the substrate, the trapped light waves reach an array of selectively reflecting surfaces 126. Note that one of the five surfaces is labeled 126 to prevent over-crowding of the drawing. Reflecting surfaces 126 couple the light waves incident upon those reflecting surfaces out of the substrate into the eye 140 of the user. More details of a light-guide optical element can be found in United States Patent Publication No. 2008/0285140, entitled “Substrate-Guided Optical Devices,” published on Nov. 20, 2008.

Head mounted display device 2 also includes a system for tracking the position of the user's eyes. As will be explained below, the system will track the user's position and orientation so that the system can determine the FOV of the user. However, a human will not perceive everything in front of them. Instead, a user's eyes will be directed at a subset of the environment. Therefore, in one embodiment, the system will include technology for tracking the position of the user's eyes in order to refine the measurement of the FOV of the user. For example, head mounted display device 2 includes eye tracking assembly 134 (FIG. 3), which has an eye tracking illumination device 134A and eye tracking camera 134B (FIG. 4). In one embodiment, eye tracking illumination device 134A includes one or more infrared (IR) emitters, which emit IR light toward the eye. Eye tracking camera 134B includes one or more cameras that sense the reflected IR light. The position of the pupil can be identified by known imaging techniques which detect the reflection of the cornea. For example, see U.S. Pat. No. 7,401,920, entitled “Head Mounted Eye Tracking and Display System”, issued Jul. 22, 2008. Such a technique can locate a position of the center of the eye relative to the tracking camera. Generally, eye tracking involves obtaining an image of the eye and using computer vision techniques to determine the location of the pupil within the eye socket. In one embodiment, it is sufficient to track the location of one eye since the eyes usually move in unison. However, it is possible to track each eye separately.

In one embodiment, the system will use four IR LEDs and four IR photo detectors in rectangular arrangement so that there is one IR LED and IR photo detector at each corner of the lens of head mounted display device 2. Light from the LEDs reflect off the eyes. The amount of infrared light detected at each of the four IR photo detectors determines the pupil direction. That is, the amount of white versus black in the eye will determine the amount of light reflected off the eye for that particular photo detector. Thus, the photo detector will have a measure of the amount of white or black in the eye. From the four samples, the system can determine the direction of the eye.

Another alternative is to use four infrared LEDs as discussed above, but one infrared CCD on the side of the lens of head mounted display device 2. The CCD will use a small mirror and/or lens (fish eye) such that the CCD can image up to 75% of the visible eye from the glasses frame. The CCD will then sense an image and use computer vision to find the image, much like as discussed above. Thus, although FIG. 3 shows one assembly with one IR transmitter, the structure of FIG. 3 can be adjusted to have four IR transmitters and/or four IR sensors. More or less than four IR transmitters and/or four IR sensors can also be used.

Another embodiment for tracking the direction of the eyes is based on charge tracking. This concept is based on the observation that a retina carries a measurable positive charge and the cornea has a negative charge. Sensors are mounted by the user's ears (near earphones 130) to detect the electrical potential while the eyes move around and effectively read out what the eyes are doing in real time. Other embodiments for tracking eyes can also be used.

FIG. 3 shows half of the head mounted display device 2. A full head mounted display device would include another set of see-through lenses, another opacity filter, another light-guide optical element, another microdisplay 120, another lens 122, room-facing camera, eye tracking assembly, micro display, earphones, and temperature sensor.

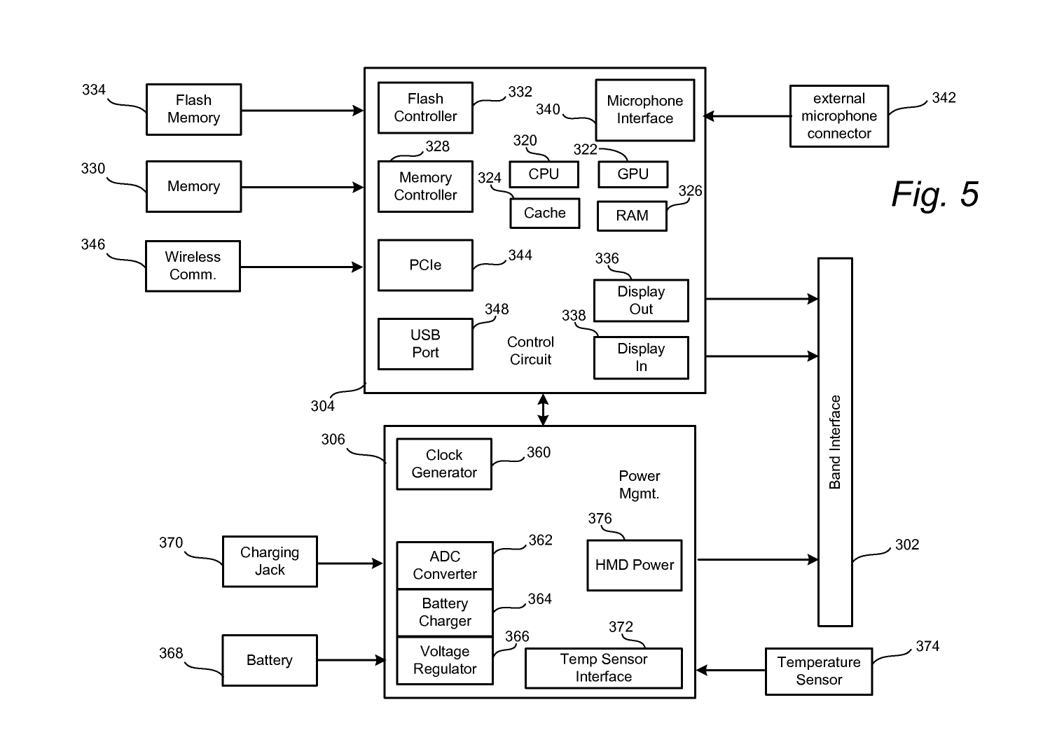

FIG. 4 is a block diagram depicting the various components of head mounted display device 2. FIG. 5 is a block diagram describing the various components of processing unit 4. Head mounted display device 2, the components of which are depicted in FIG. 4, is used to provide a mixed reality experience to the user by fusing one or more virtual images seamlessly with the user's view of the real world. Additionally, the head mounted display device components of FIG. 4 include many sensors that track various conditions. Head mounted display device 2 will receive instructions about the virtual image from processing unit 4 and will provide the sensor information back to processing unit 4. Processing unit 4, the components of which are depicted in FIG. 4, will receive the sensory information from head mounted display device 2 and will exchange information and data with the hub computing system 12 (FIG. 1). Based on that exchange of information and data, processing unit 4 will determine where and when to provide a virtual image to the user and send instructions accordingly to the head mounted display device of FIG. 4.

Some of the components of FIG. 4 (e.g., room-facing camera 112, eye tracking camera 134B, microdisplay 120, opacity filter 114, eye tracking illumination 134A, earphones 130, and temperature sensor 138) are shown in shadow to indicate that there are two of each of those devices, one for the left side and one for the right side of head mounted display device 2. FIG. 4 shows the control circuit 200 in communication with the power management circuit 202. Control circuit 200 includes processor 210, memory controller 212 in communication with memory 214 (e.g., D-RAM), camera interface 216, camera buffer 218, display driver 220, display formatter 222, timing generator 226, display out interface 228, and display in interface 230.

In one embodiment, all of the components of control circuit 200 are in communication with each other via dedicated lines or one or more buses. In another embodiment, each of the components of control circuit 200 is in communication with processor 210. Camera interface 216 provides an interface to the two room-facing cameras 112 and stores images received from the room-facing cameras in camera buffer 218. Display driver 220 will drive microdisplay 120. Display formatter 222 provides information, about the virtual image being displayed on microdisplay 120, to opacity control circuit 224, which controls opacity filter 114. Timing generator 226 is used to provide timing data for the system. Display out interface 228 is a buffer for providing images from room-facing cameras 112 to the processing unit 4. Display in interface 230 is a buffer for receiving images such as a virtual image to be displayed on microdisplay 120. Display out interface 228 and display in interface 230 communicate with band interface 232 which is an interface to processing unit 4.

Power management circuit 202 includes voltage regulator 234, eye tracking illumination driver 236, audio DAC and amplifier 238, microphone preamplifier and audio ADC 240, temperature sensor interface 242 and clock generator 244. Voltage regulator 234 receives power from processing unit 4 via band interface 232 and provides that power to the other components of head mounted display device 2. Eye tracking illumination driver 236 provides the IR light source for eye tracking illumination 134A, as described above. Audio DAC and amplifier 238 output audio information to the earphones 130. Microphone preamplifier and audio ADC 240 provides an interface for microphone 110. Temperature sensor interface 242 is an interface for temperature sensor 138. Power management circuit 202 also provides power and receives data back from three axis magnetometer 132A, three axis gyro 132B and three axis accelerometer 132C.

FIG. 5 is a block diagram describing the various components of processing unit 4. FIG. 5 shows control circuit 304 in communication with power management circuit 306. Control circuit 304 includes a central processing unit (CPU) 320, graphics processing unit (GPU) 322, cache 324, RAM 326, memory controller 328 in communication with memory 330 (e.g., D-RAM), flash memory controller 332 in communication with flash memory 334 (or other type of non-volatile storage), display out buffer 336 in communication with head mounted display device 2 via band interface 302 and band interface 232, display in buffer 338 in communication with head mounted display device 2 via band interface 302 and band interface 232, microphone interface 340 in communication with an external microphone connector 342 for connecting to a microphone, PCI express interface for connecting to a wireless communication device 346, and USB port(s) 348. In one embodiment, wireless communication device 346 can include a Wi-Fi enabled communication device, BlueTooth communication device, infrared communication device, etc. The USB port can be used to dock the processing unit 4 to hub computing system 12 in order to load data or software onto processing unit 4, as well as charge the processing unit 4. In one embodiment, CPU 320 and GPU 322 are the main workhorses for determining where, when and how to insert virtual three-dimensional objects into the view of the user. More details are provided below.

Power management circuit 306 includes clock generator 360, analog to digital converter 362, battery charger 364, voltage regulator 366, head mounted display power source 376, and temperature sensor interface 372 in communication with temperature sensor 374 (possibly located on the wrist band of processing unit 4). Analog to digital converter 362 is used to monitor the battery voltage, the temperature sensor and control the battery charging function. Voltage regulator 366 is in communication with battery 368 for supplying power to the system. Battery charger 364 is used to charge battery 368 (via voltage regulator 366) upon receiving power from charging jack 370. HMD power source 376 provides power to the head mounted display device 2.

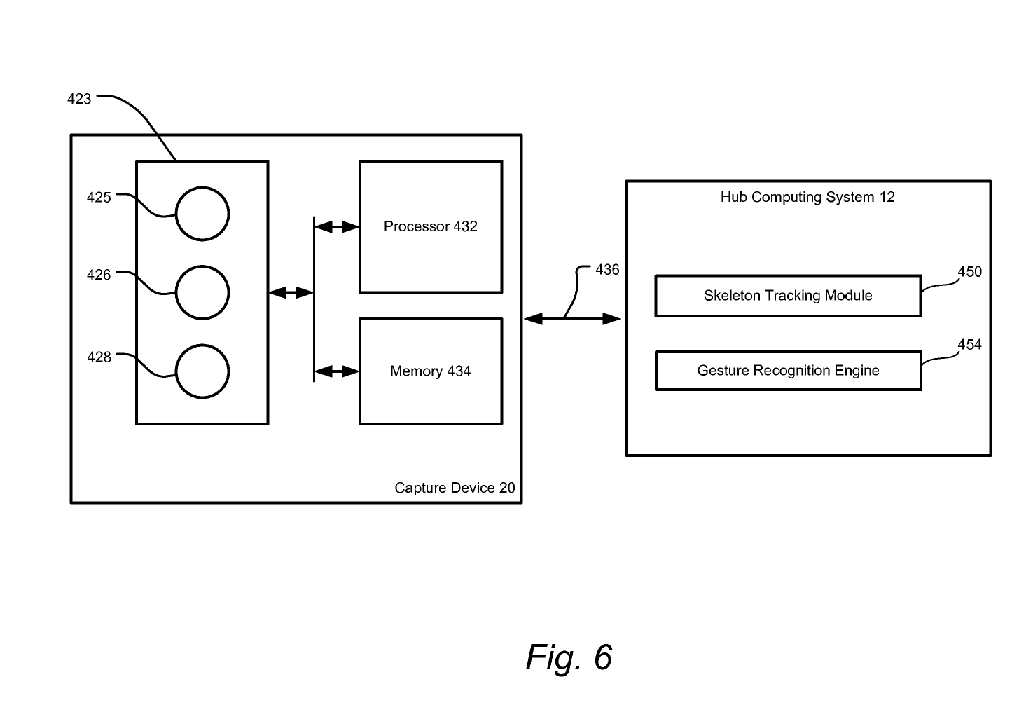

FIG. 6 illustrates an example embodiment of hub computing system 12 with a capture device 20. According to an example embodiment, capture device 20 may be configured to capture video with depth information including a depth image that may include depth values via any suitable technique including, for example, time-of-flight, structured light, stereo image, or the like. According to one embodiment, the capture device 20 may organize the depth information into “Z layers,” or layers that may be perpendicular to a Z axis extending from the depth camera along its line of sight.

As shown in FIG. 6, capture device 20 may include a camera component 423. According to an example embodiment, camera component 423 may be or may include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

Camera component 423 may include an infra-red (IR) light component 425, a three-dimensional (3-D) camera 426, and an RGB (visual image) camera 428 that may be used to capture the depth image of a scene. For example, in time-of-flight analysis, the IR light component 425 of the capture device 20 may emit an infrared light onto the scene and may then use sensors (in some embodiments, including sensors not shown) to detect the backscattered light from the surface of one or more targets and objects in the scene using, for example, the 3-D camera 426 and/or the RGB camera 428.

In an example embodiment, the capture device 20 may further include a processor 432 that may be in communication with the image camera component 423. Processor 432 may include a standardized processor, a specialized processor, a microprocessor, or the like that may execute instructions including, for example, instructions for receiving a depth image, generating the appropriate data format (e.g., frame) and transmitting the data to hub computing system 12.

Capture device 20 may further include a memory 434 that may store the instructions that are executed by processor 432, images or frames of images captured by the 3-D camera and/or RGB camera, or any other suitable information, images, or the like. According to an example embodiment, memory 434 may include random access memory (RAM), read only memory (ROM), cache, flash memory, a hard disk, or any other suitable storage component. As shown in FIG. 6, in one embodiment, memory 434 may be a separate component in communication with the image camera component 423 and processor 432. According to another embodiment, the memory 434 may be integrated into processor 432 and/or the image camera component 423.

Capture device 20 is in communication with hub computing system 12 via a communication link 436. The communication link 436 may be a wired connection including, for example, a USB connection, a Firewire connection, an Ethernet cable connection, or the like and/or a wireless connection such as a wireless 802.11b, g, a, or n connection. According to one embodiment, hub computing system 12 may provide a clock to capture device 20 that may be used to determine when to capture, for example, a scene via the communication link 436. Additionally, the capture device 20 provides the depth information and visual (e.g., RGB) images captured by, for example, the 3-D camera 426 and/or the RGB camera 428 to hub computing system 12 via the communication link 436. In one embodiment, the depth images and visual images are transmitted at 30 frames per second; however, other frame rates can be used. Hub computing system 12 may then create and use a model, depth information, and captured images to, for example, control an application such as a game or word processor and/or animate an avatar or on-screen character.

The above-described hub computing system 12, together with the head mounted display device 2 and processing unit 4, are able to insert a virtual three-dimensional object into the FOV of one or more users so that the virtual three-dimensional object augments and/or replaces the view of the real world. In one embodiment, head mounted display device 2, processing unit 4 and hub computing system 12 work together as each of the devices includes a subset of sensors that are used to obtain the data to determine where, when and how to insert the virtual three-dimensional object. In one embodiment, the calculations that determine where, when and how to insert a virtual three-dimensional object are performed by the hub computing system 12 and processing unit 4 working in tandem with each other. However, in further embodiments, all calculations may be performed by the hub computing system 12 working alone or the processing unit(s) 4 working alone. In other embodiments, at least some of the calculations can be performed by the head mounted display device 2.

The hub 12 may further include a skeletal tracking module 450 for recognizing and tracking users within the FOV of another user. A wide variety of skeletal tracking techniques exist, but some such techniques are disclosed in U.S. Pat. No. 8,437,506 entitled, “System For Fast, Probabilistic Skeletal Tracking,” issued May 7, 2013. Hub 12 may further include a gesture recognition engine 454 for recognizing gestures performed by a user. More information about gesture recognition engine 454 can be found in U.S. Patent Publication 2010/0199230, “Gesture Recognizer System Architecture,” filed on Apr. 13, 2009.

In one example embodiment, hub computing system 12 and processing units 4 work together to create the scene map or model of the environment that the one or more users are in and track various moving objects in that environment. In addition, hub computing system 12 and/or processing unit 4 track the FOV of a head mounted display device 2 worn by a user 18 by tracking the position and orientation of the head mounted display device 2. Sensor information obtained by head mounted display device 2 is transmitted to processing unit 4. In one example, that information is transmitted to the hub computing system 12 which updates the scene model and transmits it back to the processing unit. The processing unit 4 then uses additional sensor information it receives from head mounted display device 2 to refine the FOV of the user and provide instructions to head mounted display device 2 on where, when and how to insert virtual objects. Based on sensor information from cameras in the capture device 20 and head mounted display device(s) 2, the scene model and the tracking information may be periodically updated between hub computing system 12 and processing unit 4 in a closed loop feedback system as explained below.

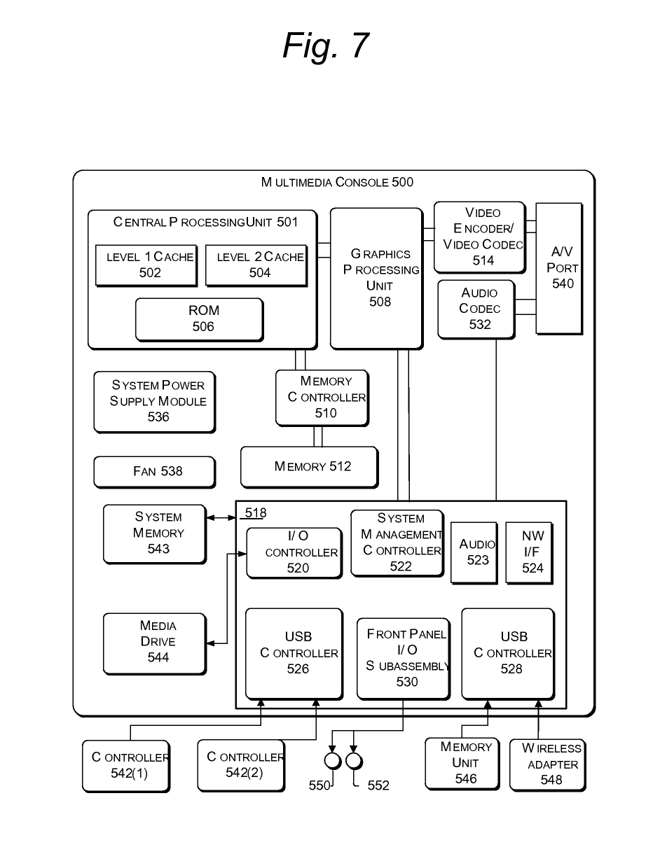

FIG. 7 illustrates an example embodiment of a computing system that may be used to implement hub computing system 12. As shown in FIG. 7, the multimedia console 500 has a central processing unit (CPU) 501 having a level 1 cache 502, a level 2 cache 504, and a flash ROM (Read Only Memory) 506. The level 1 cache 502 and a level 2 cache 504 temporarily store data and hence reduce the number of memory access cycles, thereby improving processing speed and throughput. CPU 501 may be provided having more than one core, and thus, additional level 1 and level 2 caches 502 and 504. The flash ROM 506 may store executable code that is loaded during an initial phase of a boot process when the multimedia console 500 is powered on.

A graphics processing unit (GPU) 508 and a video encoder/video codec (coder/decoder) 514 form a video processing pipeline for high speed and high resolution graphics processing. Data is carried from the graphics processing unit 508 to the video encoder/video codec 514 via a bus. The video processing pipeline outputs data to an A/V (audio/video) port 540 for transmission to a television or other display. A memory controller 510 is connected to the GPU 508 to facilitate processor access to various types of memory 512, such as, but not limited to, a RAM (Random Access Memory).

The multimedia console 500 includes an I/O controller 520, a system management controller 522, an audio processing unit 523, a network interface 524, a first USB host controller 526, a second USB controller 528 and a front panel I/O subassembly 530 that are preferably implemented on a module 518. The USB controllers 526 and 528 serve as hosts for peripheral controllers 542(1)-542(2), a wireless adapter 548, and an external memory device 546 (e.g., flash memory, external CD/DVD ROM drive, removable media, etc.). The network interface 524 and/or wireless adapter 548 provide access to a network (e.g., the Internet, home network, etc.) and may be any of a wide variety of various wired or wireless adapter components including an Ethernet card, a modem, a Bluetooth module, a cable modem, and the like.

System memory 543 is provided to store application data that is loaded during the boot process. A media drive 544 is provided and may comprise a DVD/CD drive, Blu-Ray drive, hard disk drive, or other removable media drive, etc. The media drive 544 may be internal or external to the multimedia console 500. Application data may be accessed via the media drive 544 for execution, playback, etc. by the multimedia console 500. The media drive 544 is connected to the I/O controller 520 via a bus, such as a Serial ATA bus or other high speed connection (e.g., IEEE 1394).

The system management controller 522 provides a variety of service functions related to assuring availability of the multimedia console 500. The audio processing unit 523 and an audio codec 532 form a corresponding audio processing pipeline with high fidelity and stereo processing. Audio data is carried between the audio processing unit 523 and the audio codec 532 via a communication link. The audio processing pipeline outputs data to the A/V port 540 for reproduction by an external audio user or device having audio capabilities.

The front panel I/O subassembly 530 supports the functionality of the power button 550 and the eject button 552, as well as any LEDs (light emitting diodes) or other indicators exposed on the outer surface of the multimedia console 500. A system power supply module 536 provides power to the components of the multimedia console 500. A fan 538 cools the circuitry within the multimedia console 500.

The CPU 501, GPU 508, memory controller 510, and various other components within the multimedia console 500 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 500 is powered on, application data may be loaded from the system memory 543 into memory 512 and/or caches 502, 504 and executed on the CPU 501. The application may present a graphical user interface that provides a consistent user experience when navigating to different media types available on the multimedia console 500. In operation, applications and/or other media contained within the media drive 544 may be launched or played from the media drive 544 to provide additional functionalities to the multimedia console 500.

The multimedia console 500 may be operated as a standalone system by simply connecting the system to a television or other display. In this standalone mode, the multimedia console 500 allows one or more users to interact with the system, watch movies, or listen to music. However, with the integration of broadband connectivity made available through the network interface 524 or the wireless adapter 548, the multimedia console 500 may further be operated as a participant in a larger network community. Additionally, multimedia console 500 can communicate with processing unit 4 via wireless adaptor 548.

Optional input devices (e.g., controllers 542(1) and 542(2)) are shared by gaming applications and system applications. The input devices are not reserved resources, but are to be switched between system applications and the gaming application such that each will have a focus of the device. The application manager preferably controls the switching of input stream, without knowing the gaming application's knowledge and a driver maintains state information regarding focus switches. Capture device 20 may define additional input devices for the console 500 via USB controller 526 or other interface. In other embodiments, hub computing system 12 can be implemented using other hardware architectures. No one hardware architecture is required.

The head mounted display devices 2 and processing units 4 (together referred to at times as the mobile display device) shown in FIG. 1 are in communication with one hub computing system 12 (also referred to as the hub 12). Each of the mobile display devices may communicate with the hub using wireless communication, as described above. In such an embodiment, it is contemplated that much of the information that is useful to the mobile display devices will be computed and stored at the hub and transmitted to each of the mobile display devices. For example, the hub will generate the model of the environment and provide that model to all of the mobile display devices in communication with the hub. Additionally, the hub can track the location and orientation of the mobile display devices and of the moving objects in the room, and then transfer that information to each of the mobile display devices.

In another embodiment, a system could include multiple hubs 12, with each hub including one or more mobile display devices. The hubs can communicate with each other directly or via the Internet (or other networks). Such an embodiment is disclosed in U.S. patent application Ser. No. 12/905,952 to Flaks et al., entitled “Fusing Virtual Content Into Real Content,” filed Oct. 15, 2010.

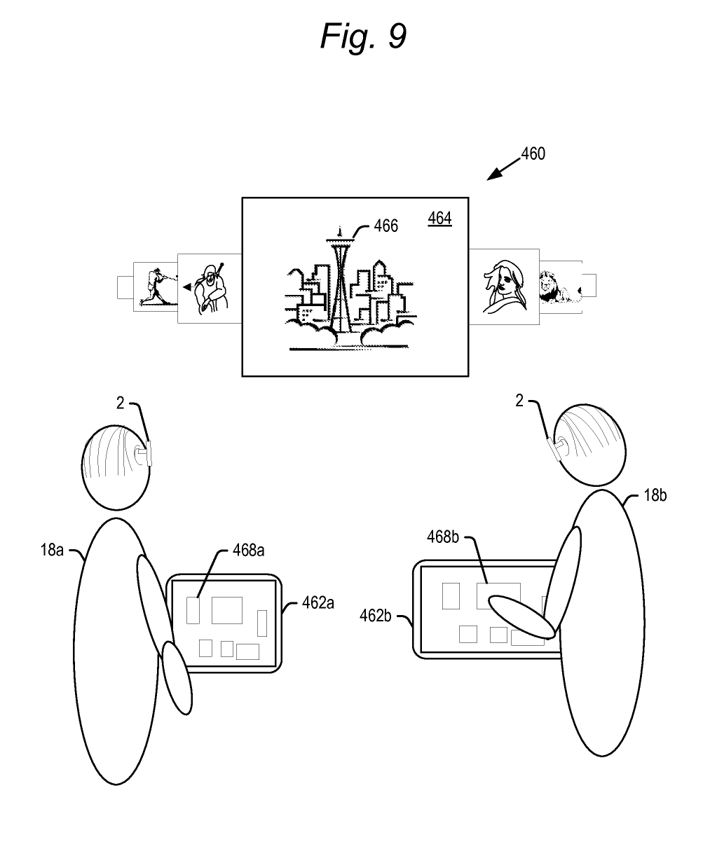

Moreover, in further embodiments, the hub 12 may be omitted altogether. One benefit of such an embodiment is that the mixed reality experience of the present system becomes fully mobile, and may be used in both indoor or outdoor settings. In such an embodiment, all functions performed by the hub 12 in the description that follows may alternatively be performed by one of the processing units 4, some of the processing units 4 working in tandem, or all of the processing units 4 working in tandem. In such an embodiment, the respective mobile display devices 2 perform all functions of system 10, including generating and updating state data, a scene map, each user's view of the scene map, all texture and rendering information, video and audio data, and other information to perform the operations described herein. The embodiments described below with respect to the flowchart of FIG. 9 include a hub 12. However, in each such embodiment, one or more of the processing units 4 may alternatively perform all described functions of the hub 12.

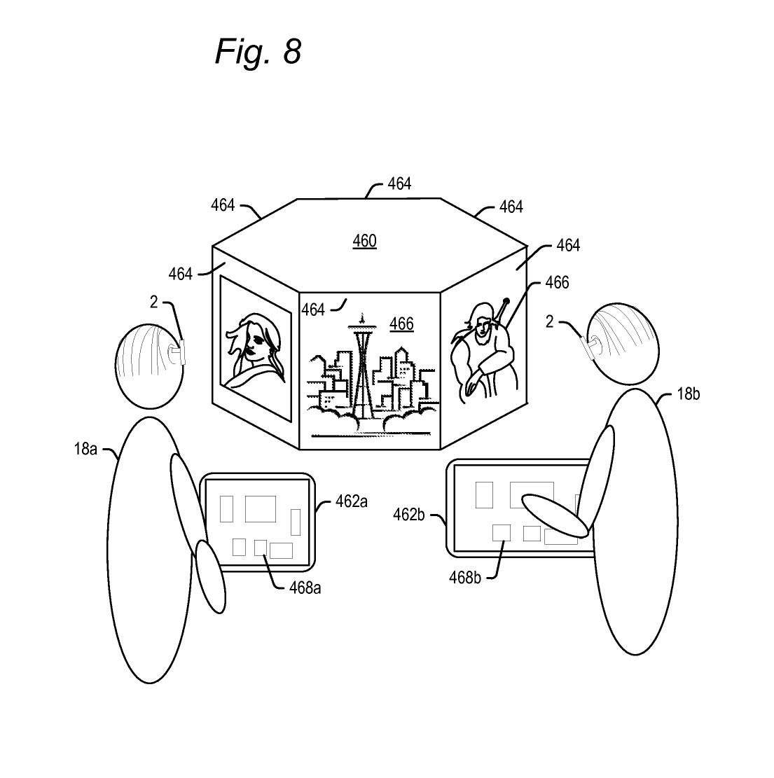

FIG. 8 illustrates an example of the present technology, including a shared virtual object 460 and private virtual objects 462a, 462b (collectively, private virtual objects 462). The virtual objects 460, 462 shown in FIG. 8 and other figures would be visible through head mounted display devices 2.

The shared virtual object 460 is visible to and shared between various users, two users 18a, 18b in the example of FIG. 8. Each user is able to see the same shared object 460, from their own perspective, and the users are able to collaboratively interact with the shared object 460 as explained below. While FIG. 8 shows a single shared virtual object 460, it is understood that there may be more than one shared virtual objects in further embodiments. Where there are multiple shared virtual objects, they may be related to each other or independent from each other.

The shared virtual object may be defined by state data, including for example the appearance, content, position in three dimensional space, the degree to which the object is interactive or some of these attributes. The state data may change from time to time, for example when a shared virtual object is moved, the content is changed or it is interacted with in some way. Users 18a, 18b (and other users if present) may each receive the same state data for shared virtual objects 460, and each may receive the same updates to the state data. Accordingly, the users may see the same shared virtual object(s), though from their own perspective, and the users may each see the same changes as they are made to the shared virtual object 460 by one or more of the users and/or a software application controlling the shared virtual object 460.

As one of many examples, the shared virtual object 460 shown in FIG. 8 is a virtual carousel including a number of virtual display slates 464 around a periphery of the virtual carousel. Each display slate 464 may display different content 466. The opacity filter 114 (described above) is used to mask real world objects and light behind (from the user's view point) each virtual display slate 464, so that each virtual display slate 464 appears as a virtual screen for displaying content. The number of display slates 464 shown in FIG. 8 is by of example and may vary in further embodiments. The head mounted display device 2 for each user is able to display the virtual display slates 464, and content 466 on the virtual display slates, from each user's perspective. As noted above, the content and the position of the virtual carousel in three dimensional space may be the same for each user 18a, 18b.

The content displayed on each virtual display slate 464 may be a wide variety of content, including static content such as photographs, illustrations, text and graphics, or dynamic content such as video. A virtual display slate 464 may further act as a computer monitor, so that the content 466 may be email, web pages, games or any other content presented on a monitor. A software application running on hub 12 may determine the content to be displayed on virtual display slates 464. Alternatively or additionally, users may add, alter or remove content 466 from the virtual display slates 464

Each user 18a, 18b may walk around the virtual carousel to view the different content 466 on the different display slates 464. As explained in greater detail below, the positions of each respective display slate 464 is known in the three dimensional space of the scene, and the FOV of each head mounted display device 2 is known. Thus, each head mounted display is able to determine where the user is looking, what display slate(s) 464 are within that user's FOV, and how the content 466 appears on those display slate(s) 464.

It is a feature of the present technology that users may collaborate together on shared virtual objects, for example using their own private virtual objects (explained below). In the example of FIG. 8, the users 18a, 18b may interact with the virtual carousel to rotate it and view the different content 466 on the different display slates 464. When one of the users 18a, 18b interacts with the virtual carousel to rotate it, the state data for the shared virtual object 460 is updated for each of the users. The net effect is that, when one user rotates the virtual carousel, the virtual carousel rotates in the same manner for all users viewing the virtual carousel.

In some embodiments, a user may be able to interact with the content 466 in shared virtual object 460 to remove, add and/or alter displayed content. Once content is altered by a user or a software application controlling the shared virtual object 460, those alterations would be visible to each user 18a, 18b.

In embodiments, each user may have the same ability to view and interact with shared virtual objects. In further embodiments, different users may have different permission policies defining the degree to which the different users may interact with the shared virtual object 460. Permission policies may be defined by a software application presenting the shared virtual object 460 and/or by one or more users. As an example, one of the users 18a, 18b may be presenting a slide show or other presentation to the other user(s). In such an example, the user presenting the slide show may have the ability to rotate the virtual carousel while the other user(s) may not.

It is also conceivable that certain portions of the shared virtual content be visible to some users but not others, depending on the definitions in the users' permissions policies. Again, these permission policies may be defined by a software application presenting the shared virtual object 460 and/or by one or more users. Continuing with the slide show example, the user presenting the slide show may have notes on the slide show that are visible to the presenter, not others. The description of a slide show is just an example, and there may be a wide variety of other scenarios where different users have different permissions to view and/or interact with the shared virtual object(s) 460.

In addition to shared virtual objects, the present technology may include private virtual objects 462. User 18a has a private virtual object 462a and user 18b has a private virtual object 462b. In an example including additional users, each such additional user may have his or her own private virtual object 462. A user may have more than one private virtual object 462 in further embodiments.

Unlike shared virtual objects, private virtual objects 462 may just be visible to a user with which a private virtual object 462 is associated. Thus, the private virtual object 462a may be visible to user 18a but not 18b. The private virtual object 462b may be visible to user 18b but not 18a. Moreover, in embodiments, state data generated for, by or relating to a user's private virtual object 462 is not shared among multiple users.

It is conceivable that state data for a private virtual object be shared among more than one user, and that a private virtual object be visible to more than one user, in further embodiments. The sharing of state data and the ability of a user 18 to see another's private virtual object 462 may be defined in a permission policy for that user. As above, that permission policy may be set by an application presenting the private virtual object(s) 462 and/or one or more of the users 18.

Private virtual objects 462 may be provided for a wide variety of purposes, and may be in a wide variety of forms or include a wide variety of content. In one example, a private virtual object 462 may be used to interact with the shared virtual object 460. In the example of FIG. 8, the private virtual object 462a may include virtual objects 468a such as controls or content that allow the user 18a to interact with the shared virtual object 460. For example, the private virtual object 462a may have virtual controls allowing user 18a to add, delete or change content on the shared virtual object 460, or rotate the carousel of the shared virtual object 460. Similarly, the private virtual object 462b may have virtual controls allowing user 18b to add, delete or change content on the shared virtual object 460, or rotate the carousel of the shared virtual object 460.

The private virtual objects 468 may enable interaction with the shared virtual objects 460 in a wide variety of manners. In general, interactions with a user's private virtual object 468 may be defined by a software application controlling the private virtual object 468. When a user interacts with his or her private virtual object 468 in a defined manner, the software application may affect an associated change in or interaction on the shared virtual object 460. In the example of FIG. 8, each user's private virtual object 468 may include a swipe bar so that, when a user swipes his or her finger over the bar, the virtual carousel rotates in the direction of the finger swipe. A wide variety of other controls and defined interactions may be provided for a user to interact with his or her private virtual object 468 to affect some change or interaction with shared virtual object 460.

Using the private virtual objects 468, it may happen that the interactions of different users with a shared object 460 may conflict with each other. For example, in the example of FIG. 8, one user may attempt to rotate the virtual carousel in one direction, while the other user may attempt to rotate the virtual carousel in the opposite direction. A software application controlling the shared virtual object 460 and/or private virtual objects 462 may have a conflict resolution scheme for dealing with such conflicts. For example, one of the users may have priority over the other with respect to interacting with the shared object 460, as defined in their respective permissions policies. Alternatively, a new shared virtual object 460 may appear to both users alerting them as to the conflict and giving them the opportunity to resolve it.

Private virtual objects 468 may have uses other than for the interaction with the shared virtual object 460. Private virtual objects 468 may be used to display a variety of information and content to a user which is kept private to that user.

The shared virtual object(s) may be in any of a variety of forms and/or present any of a variety of different content. FIG. 9 is an example similar to FIG. 8, but where virtual display slates 464 can float past the users instead of being assembled into a virtual carousel. As in the example of FIG. 8, each user may have a private virtual object 462 for interacting with the shared virtual object 460. For example, each private virtual object 462a, 462b may include controls to scroll the virtual display slates 464 in either direction. The private virtual objects 462a, 462b may further include controls for interacting with the virtual display slates 464 or shared virtual object 460 in other ways, for example to alter, add or remove content from the shared virtual object 460.

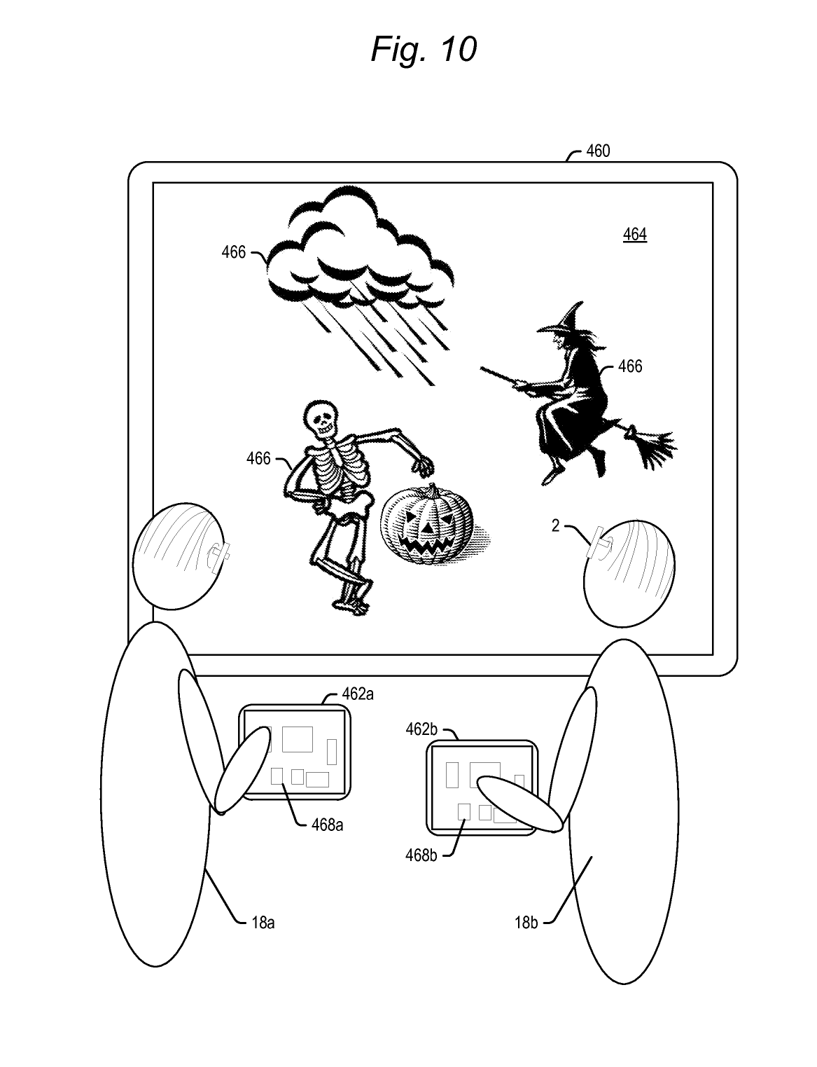

In embodiments, the shared virtual object 460 and private virtual objects 462 may be provided to facilitate collaboration between users on the shared virtual object 460. In the example shown in FIGS. 8 and 9, users may collaborate in viewing and scanning through content 466 on the various virtual display slates 464. It may be that one of the users is presenting the slideshow or presentation, or it may be that the multiple users 18 are simply viewing the content together. FIG. 10 is an embodiment where users 18 may collaborate together in creating content 466 on a virtual display slate 464.

For example, the users 18 may be working together to create a painting, picture or other image. Each user may have a private virtual object 462a, 462b which they can interact with and add content to the shared virtual object 460. In further embodiments, the shared virtual object 460 may be broken down into different regions, with each user adding content to an assigned region via their private virtual object 462.

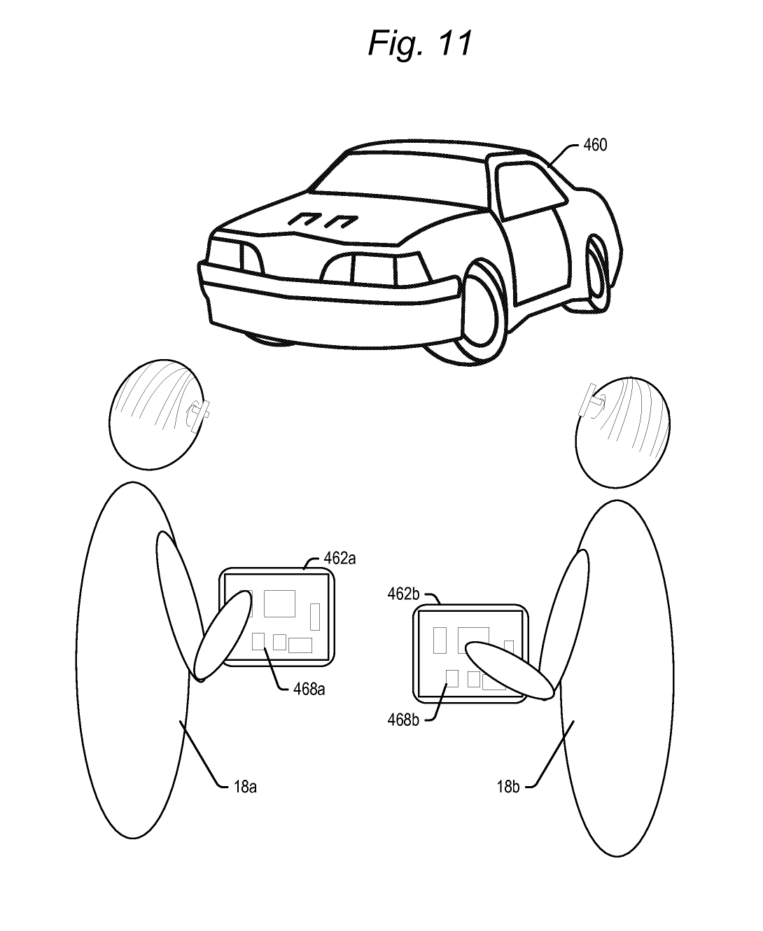

In the examples of FIGS. 8 and 9, the shared virtual object 460 is in the form of multiple virtual display slates 464, and in the example of FIG. 10, the shared virtual object 460 is in the form of a single virtual display slate 464. However, the shared virtual object need not be a virtual display slate in further embodiments. One such example is shown in FIG. 11. In this embodiment, users 18 are collaborating together to create and/or modify a shared virtual object 460 in the form of a virtual automobile. As explained above, the users may collaborate to create and/or modify the virtual automobile by interacting with their private virtual objects 462a, 462b, respectively.

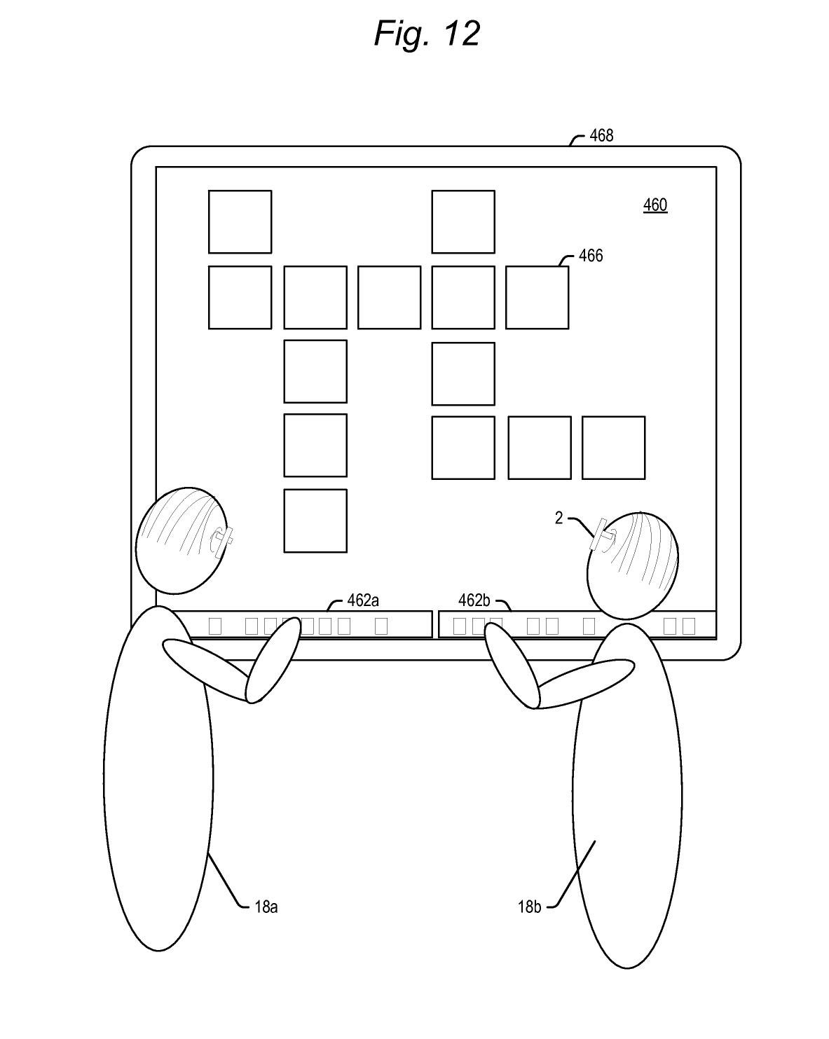

In embodiments described above, the shared virtual object 460 and private virtual objects 462 are separated in space. They need not be in further embodiments. FIG. 12 shows such an embodiment including a hybrid virtual object 468 including portions which are the private virtual objects 462 and portions which are the shared virtual object(s) 460. It is understood that the positions of both the private virtual objects 462 and shared virtual object(s) 460 may vary on the hybrid virtual object 468. In this example, the users 18 may be playing a game on the shared virtual object 460, with the private virtual objects 462 of each user controlling what takes place on the shared virtual object 460. As above, each user may view his own private virtual object 462 but may not be able to view the other user's private virtual object 462.

As noted above, in embodiments, all users 18 may view and collaborate on a single, common shared virtual object 460. The shared virtual object 460 may be positioned in a default position in three-dimensional space so which may be initially set by a software application providing the shared virtual object 460 or one or more of the users. Thereafter, the shared virtual object 460 may remain stationary in three-dimensional space, or it may be movable by one or more of the users 18 and/or a software application providing the shared virtual object 460.

Where one of the users 18 has control of the shared virtual object 460, for example as defined in the permissions policies of the respective users, it is conceivable that the shared virtual object 460 be body locked to the user having control of the shared virtual object 460. In such an embodiment, the shared virtual object 460 may move with the controlling user 18, and the remaining users 18 may move with the controlling user 18 to maintain their view of the shared virtual object 460.

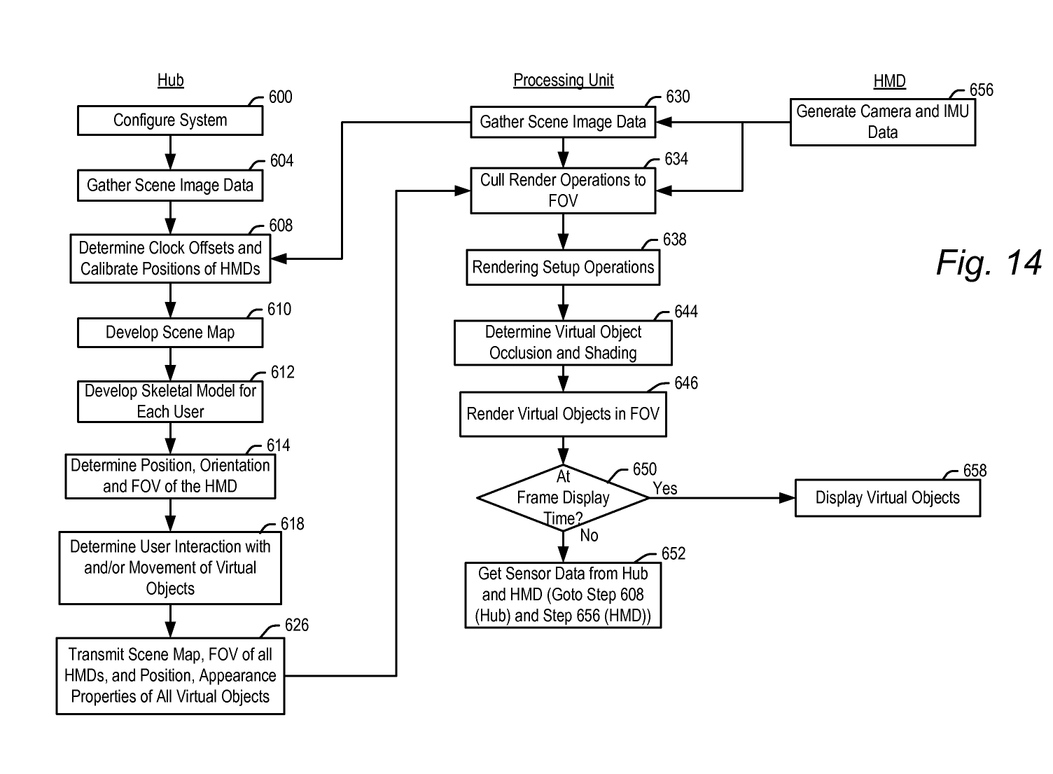

In a further embodiment shown in FIG. 14, each user may have their own copy of a single shared virtual object 460. That is, the state data for each copy of the shared virtual object 460 may remain the same for each of the users 18. Thus, for example, if one of the users 18 alters content on a virtual display slate 464, that alteration may show up on all copies of the shared virtual object 460. However, each user 18 is free to interact with their copy of the shared virtual object 460. In the example of FIG. 12, one user 18 may have rotated their copy of the virtual carousel to a different orientation and the other user. In the example of FIG. 12, the users 18a, 18b are viewing the same image, for example collaborating to alter the image. However, as in the above examples, each user may move around their copy of the shared virtual object 460 so as to view different images and/or view the shared object 460 from different distances and perspectives. Where each user has their own copy of the shared virtual object 460, one user's copy of the shared virtual object 460 may or may not be visible to other users.

FIGS. 8 through 13 illustrate a few examples of how one or more shared virtual objects 460 and private virtual objects 462 may be presented to users 18, and how they may interact with the one or more shared virtual objects 460 and private virtual objects 462. It is understood that the one or more shared virtual objects 460 and private virtual objects 462 may have a wide variety of other appearances, interactive features and functions.

FIG. 14 is a high level flowchart of the operation and interactivity of the hub computing system 12, the processing unit 4 and head mounted display device 2 during a discrete time period such as the time it takes to generate, render and display a single frame of image data to each user. In embodiments, data may be refreshed at a rate of 60 Hz, though it may be refreshed more often or less often in further embodiments.

In general, the system generates a scene map having x, y, z coordinates of the environment and objects in the environment such as users, real world objects and virtual objects. As noted above, the shared virtual object(s) 460 and private virtual object(s) 462 may be virtually placed in the environment for example by an application running on hub computing system 12 or by one or more users 18. The system also tracks the FOV of each user. While all users may possibly be viewing the same aspects of the scene, they are viewing them from different perspectives. Thus, the system generates each person's FOV of the scene to adjust for parallax and occlusion of virtual or real world objects, which may again be different for each user.

For a given frame of image data, a user's view may include one or more real and/or virtual objects. As a user turns his/her head, for example left to right or up and down, the relative position of real world objects in the user's FOV inherently moves within the user's FOV. For example, plant 23 in FIG. 1 may appear on the right side of a user's FOV at first. But if the user then turns his/her head toward the right, the plant 23 may eventually end up on the left side of the user's FOV.

However, the display of virtual objects to a user as the user moves his head is a more difficult problem. In an example where a user is looking at a world locked virtual object in his FOV, if the user moves his head left to move the FOV left, the display of the virtual object needs to be shifted to the right by an amount of the user's FOV shift, so that the net effect is that the virtual object remains stationary within the FOV. A system for properly displaying world and body locked virtual objects is explained below with respect to the flowchart of FIGS. 14-17.

The system for presenting mixed reality to one or more users 18 may be configured in step 600. For example, a user 18 or operator of the system may specify the virtual objects that are to be presented, including for example the shared virtual object(s) 460. The users may also configure the contents the shared virtual object(s) 460 and/or of their own private virtual object(s) 462, as well as how, when and where they are to be presented.

In steps 604 and 630, hub 12 and processing unit 4 gather data from the scene. For the hub 12, this may be image and audio data sensed by the depth camera 426 and RGB camera 428 of capture device 20. For the processing unit 4, this may be image data sensed in step 656 by the head mounted display device 2, and in particular, by the cameras 112, the eye tracking assemblies 134 and the IMU 132. The data gathered by the head mounted display device 2 is sent to the processing unit 4 in step 656. The processing unit 4 processes this data, as well as sending it to the hub 12 in step 630.

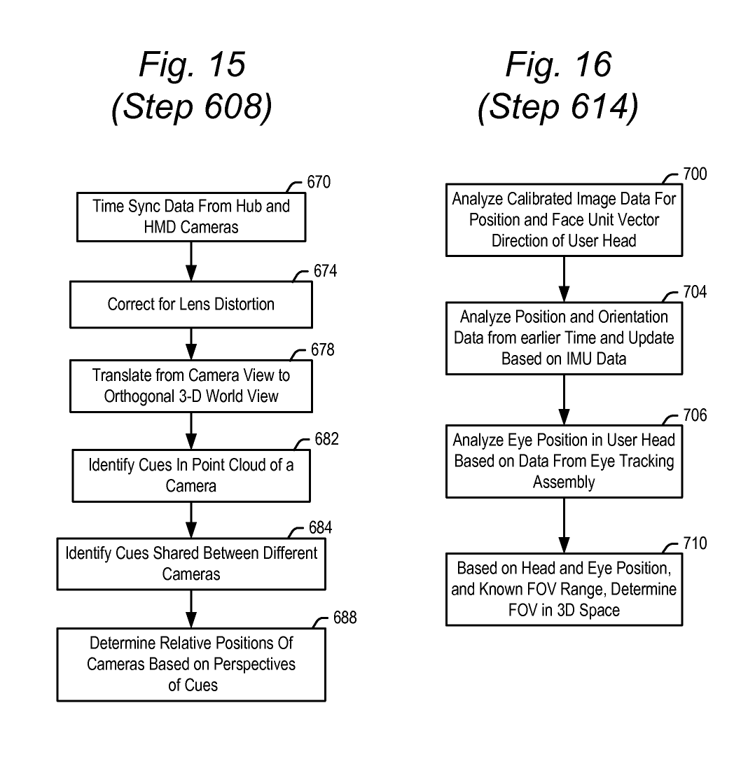

In step 608, the hub 12 performs various setup operations that allow the hub 12 to coordinate the image data of its capture device 20 and the one or more processing units 4. In particular, even if the position of the capture device 20 is known with respect to a scene (which it may not be), the cameras on the head mounted display devices 2 are moving around in the scene. Therefore, in embodiments, the positions and time capture of each of the imaging cameras need to be calibrated to the scene, each other and the hub 12. Further details of step 608 are now described with reference to the flowchart of FIG. 15.

One operation of step 608 includes determining clock offsets of the various imaging devices in the system 10 in a step 670. In particular, in order to coordinate the image data from each of the cameras in the system, it may be confirmed that the image data being coordinated is from the same time. Details relating to determining clock offsets and synching of image data are disclosed in U.S. patent application Ser. No. 12/772,802, entitled “Heterogeneous Image Sensor Synchronization,” filed May 3, 2010, and U.S. patent application Ser. No. 12/792,961, entitled “Synthesis Of Information From Multiple Audiovisual Sources,” filed Jun. 3, 2010. In general, the image data from capture device 20 and the image data coming in from the one or more processing units 4 are time stamped off a single master clock in hub 12. Using the time stamps for all such data for a given frame, as well as the known resolution for each of the cameras, the hub 12 determines the time offsets for each of the imaging cameras in the system. From this, the hub 12 may determine the differences between, and an adjustment to, the images received from each camera.

The hub 12 may select a reference time stamp from one of the cameras' received frame. The hub 12 may then add time to or subtract time from the received image data from all other cameras to synch to the reference time stamp. It is appreciated that a variety of other operations may be used for determining time offsets and/or synchronizing the different cameras together for the calibration process. The determination of time offsets may be performed once, upon initial receipt of image data from all the cameras. Alternatively, it may be performed periodically, such as for example each frame or some number of frames.

Step 608 further includes the operation of calibrating the positions of all cameras with respect to each other in the x, y, z Cartesian space of the scene. Once this information is known, the hub 12 and/or the one or more processing units 4 is able to form a scene map or model identify the geometry of the scene and the geometry and positions of objects (including users) within the scene. In calibrating the image data of all cameras to each other, depth and/or RGB data may be used. Technology for calibrating camera views using RGB information alone is described for example in U.S. Patent Publication No. 2007/0110338, entitled “Navigating Images Using Image Based Geometric Alignment and Object Based Controls,” published May 17, 2007.

The imaging cameras in system 10 may each have some lens distortion which needs to be corrected for in order to calibrate the images from different cameras. Once all image data from the various cameras in the system is received in steps 604 and 630, the image data may be adjusted to account for lens distortion for the various cameras in step 674. The distortion of a given camera (depth or RGB) may be a known property provided by the camera manufacturer. If not, algorithms are known for calculating a camera's distortion, including for example imaging an object of known dimensions such as a checker board pattern at different locations within a camera's FOV. The deviations in the camera view coordinates of points in that image will be the result of camera lens distortion. Once the degree of lens distortion is known, distortion may be corrected by known inverse matrix transformations that result in a uniform camera view map of points in a point cloud for a given camera.

The hub 12 may next translate the distortion-corrected image data points captured by each camera from the camera view to an orthogonal 3-D world view in step 678. This orthogonal 3-D world view is a point cloud map of all image data captured by capture device 20 and the head mounted display device cameras in an orthogonal x, y, z Cartesian coordinate system. The matrix transformation equations for translating camera view to an orthogonal 3-D world view are known. See, for example, David H. Eberly, “3d Game Engine Design: A Practical Approach To Real-Time Computer Graphics,” Morgan Kaufman Publishers (2000). See also, U.S. patent application Ser. No. 12/792,961, mentioned above.

Each camera in system 10 may construct an orthogonal 3-D world view in step 678. The x, y, z world coordinates of data points from a given camera are still from the perspective of that camera at the conclusion of step 678, and not yet correlated to the x, y, z world coordinates of data points from other cameras in the system 10. The next step is to translate the various orthogonal 3-D world views of the different cameras into a single overall 3-D world view shared by all cameras in system 10.

To accomplish this, embodiments of the hub 12 may next look for key-point discontinuities, or cues, in the point clouds of the world views of the respective cameras in step 682, and then identifies cues that are the same between different point clouds of different cameras in step 684. Once the hub 12 is able to determine that two world views of two different cameras include the same cues, the hub 12 is able to determine the position, orientation and focal length of the two cameras with respect to each other and the cues in step 688. In embodiments, not all cameras in system 10 will share the same common cues. However, as long as a first and second camera have shared cues, and at least one of those cameras has a shared view with a third camera, the hub 12 is able to determine the positions, orientations and focal lengths of the first, second and third cameras relative to each other and a single, overall 3-D world view. The same is true for additional cameras in the system.

Various known algorithms exist for identifying cues from an image point cloud. Such algorithms are set forth for example in Mikolajczyk, K., and Schmid, C., “A Performance Evaluation of Local Descriptors,” IEEE Transactions on Pattern Analysis & Machine Intelligence, 27, 10, 1615-1630. (2005). A further method of detecting cues with image data is the Scale-Invariant Feature Transform (SIFT) algorithm. The SIFT algorithm is described for example in U.S. Pat. No. 6,711,293, entitled, “Method and Apparatus for Identifying Scale Invariant Features in an Image and Use of Same for Locating an Object in an Image,” issued Mar. 23, 2004. Another cue detector method is the Maximally Stable Extremal Regions (MSER) algorithm. The MSER algorithm is described for example in the paper by J. Matas, O. Chum, M. Urba, and T. Pajdla, “Robust Wide Baseline Stereo From Maximally Stable Extremal Regions,” Proc. of British Machine Vision Conference, pages 384-396 (2002).

In step 684, cues which are shared between point clouds from two or more cameras are identified. Conceptually, where a first set of vectors exist between a first camera and a set of cues in the first camera's Cartesian coordinate system, and a second set of vectors exist between a second camera and that same set of cues in the second camera's Cartesian coordinate system, the two systems may be resolved with respect to each other into a single Cartesian coordinate system including both cameras. A number of known techniques exist for finding shared cues between point clouds from two or more cameras. Such techniques are shown for example in Arya, S., Mount, D. M., Netanyahu, N. S., Silverman, R., and Wu, A. Y., “An Optimal Algorithm For Approximate Nearest Neighbor Searching Fixed Dimensions,” Journal of the ACM 45, 6, 891-923 (1998). Other techniques can be used instead of, or in addition to, the approximate nearest neighbor solution of Arya et al., mentioned above, including but not limited to hashing or context-sensitive hashing.

Where the point clouds from two different cameras share a large enough number of matched cues, a matrix correlating the two point clouds together may be estimated, for example by Random Sampling Consensus (RANSAC), or a variety of other estimation techniques. Matches that are outliers to the recovered fundamental matrix may then be removed. After finding a set of assumed, geometrically consistent matches between a pair of point clouds, the matches may be organized into a set of tracks for the respective point clouds, where a track is a set of mutually matching cues between point clouds. A first track in the set may contain a projection of each common cue in the first point cloud. A second track in the set may contain a projection of each common cue in the second point cloud. The point clouds from different cameras may then be resolved into a single point cloud in a single orthogonal 3-D real world view.

The positions and orientations of all cameras are calibrated with respect to this single point cloud and single orthogonal 3-D real world view. In order to resolve the various point clouds together, the projections of the cues in the set of tracks for two point clouds are analyzed. From these projections, the hub 12 can determine the perspective of a first camera with respect to the cues, and can also determine the perspective of a second camera with respect to the cues. From that, the hub 12 can resolve the point clouds into an estimate of a single point cloud and single orthogonal 3-D real world view containing the cues and other data points from both point clouds.

This process is repeated for any other cameras, until the single orthogonal 3-D real world view includes all cameras. Once this is done, the hub 12 can determine the relative positions and orientations of the cameras relative to the single orthogonal 3-D real world view and each other. The hub 12 can further determine the focal length of each camera with respect to the single orthogonal 3-D real world view.

Once the system is calibrated in step 608, a scene map may be developed in step 610 identifying the geometry of the scene as well as the geometry and positions of objects within the scene. In embodiments, the scene map generated in a given frame may include the x, y and z positions of all users, real world objects and virtual objects in the scene. This information may be obtained during the image data gathering steps 604, 630 and 656 and is calibrated together in step 608.

At least the capture device 20 includes a depth camera for determining the depth of the scene (to the extent it may be bounded by walls, etc.) as well as the depth position of objects within the scene. As explained below, the scene map is used in positioning virtual objects within the scene, as well as displaying virtual three-dimensional objects with the proper occlusion (a virtual three-dimensional object may be occluded, or a virtual three-dimensional object may occlude, a real world object or another virtual three-dimensional object).

The system 10 may include multiple depth image cameras to obtain all of the depth images from a scene, or a single depth image camera, such as for example depth image camera 426 of capture device 20 may be sufficient to capture all depth images from a scene. An analogous method for determining a scene map within an unknown environment is known as simultaneous localization and mapping (SLAM). One example of SLAM is disclosed in U.S. Pat. No. 7,774,158, entitled “Systems and Methods for Landmark Generation for Visual Simultaneous Localization and Mapping,” issued Aug. 10, 2010.

In step 612, the system may detect and track moving objects such as humans moving in the room, and update the scene map based on the positions of moving objects. This includes the use of skeletal models of the users within the scene as described above.

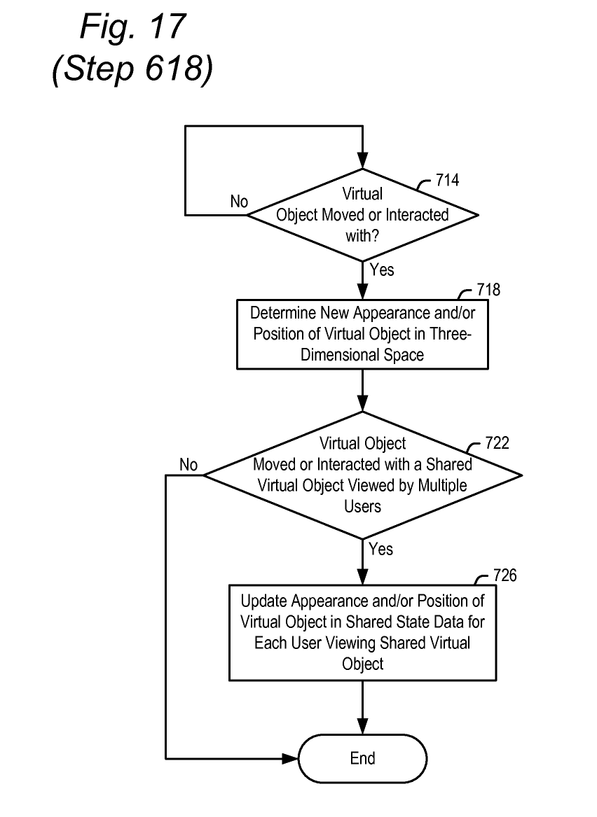

In step 614, the hub determines the x, y and z position, the orientation and the FOV of the head mounted display devices 2 of the various users 18. Further details of step 614 are now described with respect to the flowchart of FIG. 16. The steps of FIG. 16 are described below with respect to a single user. However, the steps of FIG. 16 may be carried out for each user within the scene.

In step 700, the calibrated image data for the scene is analyzed at the hub to determine both the user head position and a face unit vector looking straight out from a user's face. The head position is identified in the skeletal model. The face unit vector may be determined by defining a plane of the user's face from the skeletal model, and taking a vector perpendicular to that plane. This plane may be identified by determining a position of a user's eyes, nose, mouth, ears or other facial features. The face unit vector may be used to define the user's head orientation and, in examples, may be considered the center of the FOV for the user. The face unit vector may also or alternatively be identified from the camera image data returned from the cameras 112 on head mounted display device 2. In particular, based on what the cameras 112 on head mounted display device 2 see, the associated processing unit 4 and/or hub 12 is able to determine the face unit vector representing a user's head orientation.

In step 704, the position and orientation of a user's head may also or alternatively be determined from analysis of the position and orientation of the user's head from an earlier time (either earlier in the frame or from a prior frame), and then using the inertial information from the IMU 132 to update the position and orientation of a user's head. Information from the IMU 132 may provide accurate kinematic data for a user's head, but the IMU typically does not provide absolute position information regarding a user's head. This absolute position information, also referred to as “ground truth,” may be provided from the image data obtained from capture device 20, the cameras on the head mounted display device 2 for the subject user and/or from the head mounted display device(s) 2 of other users.

In embodiments, the position and orientation of a user's head may be determined by steps 700 and 704 acting in tandem. In further embodiments, one or the other of steps 700 and 704 may be used to determine head position and orientation of a user's head.

It may happen that a user is not looking straight ahead. Therefore, in addition to identifying user head position and orientation, the hub may further consider the position of the user's eyes in his head. This information may be provided by the eye tracking assembly 134 described above. The eye tracking assembly is able to identify a position of the user's eyes, which can be represented as an eye unit vector showing the left, right, up and/or down deviation from a position where the user's eyes are centered and looking straight ahead (i.e., the face unit vector). A face unit vector may be adjusted to the eye unit vector to define where the user is looking.

In step 710, the FOV of the user may next be determined. The range of view of a user of a head mounted display device 2 may be predefined based on the up, down, left and right peripheral vision of a hypothetical user. In order to ensure that the FOV calculated for a given user includes objects that a particular user may be able to see at the extents of the FOV, this hypothetical user may be taken as one having a maximum possible peripheral vision. Some predetermined extra FOV may be added to this to ensure that enough data is captured for a given user in embodiments.

The FOV for the user at a given instant may then be calculated by taking the range of view and centering it around the face unit vector, adjusted by any deviation of the eye unit vector. In addition to defining what a user is looking at in a given instant, this determination of a user's FOV is also useful for determining what a user cannot see. As explained below, limiting processing of virtual objects to those areas that a particular user can see improves processing speed and reduces latency.

In the embodiment described above, the hub 12 calculates the FOV of the one or more users in the scene. In further embodiments, the processing unit 4 for a user may share in this task. For example, once user head position and eye orientation are estimated, this information may be sent to the processing unit which can update the position, orientation, etc. based on more recent data as to head position (from IMU 132) and eye position (from eye tracking assembly 134).

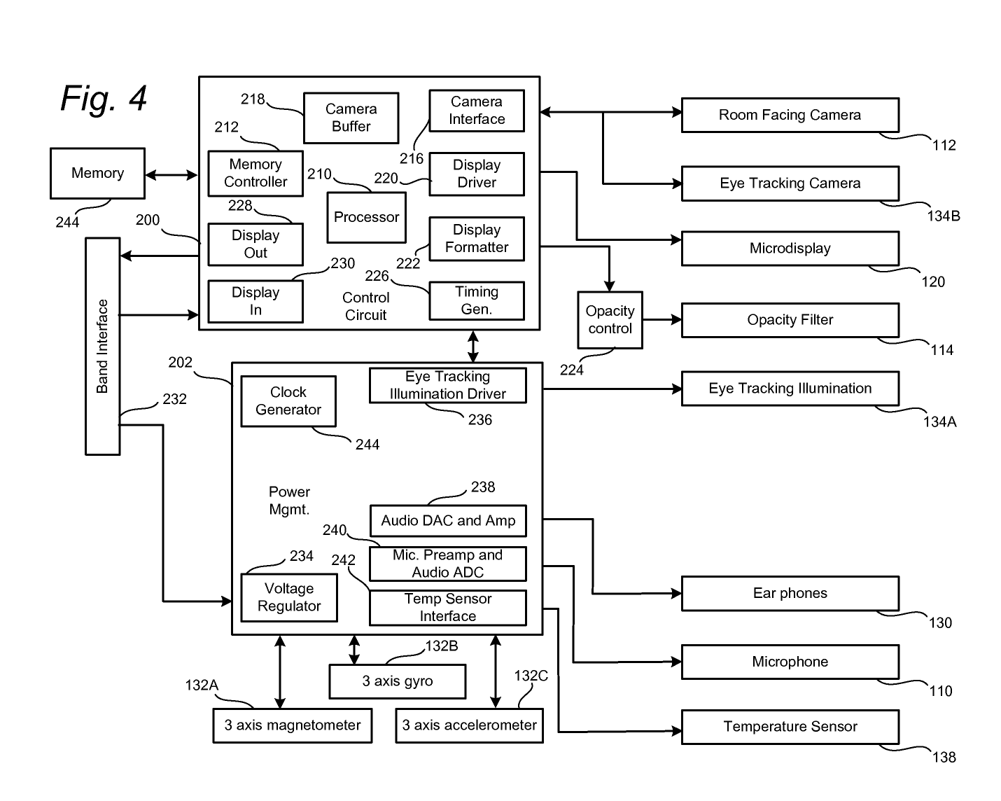

Returning now to FIG. 14, in step 618 the hub 12 may determine user interaction with virtual objects and/or positions of virtual objects. These virtual objects may include the shared virtual object(s) 460 and/or each user's private virtual object(s) 462. For example, a shared virtual object 460, viewed by a single user or by multiple users, may have moved. Further details of step 618 are set forth in the flowchart of FIG. 17.

In step 714, the hub may determine whether one or more virtual objects have been interacted with or moved. If so, the hub determines the new appearance and/or position of the affected virtual object in three-dimensional space. As noted above, different gestures may have defined effects on virtual objects in the scene. As one example, a user may interact with their private virtual object 462, which in turn affects some interaction with the shared virtual object 460. These interactions are sensed in step 714, and the effects of these interactions on both the private virtual object 462 and the shared virtual object(s) 460 are implemented in step 718.

In step 722, the hub 12 checks whether a moved or interacted with is a virtual object 460 shared by multiple users. If so, the hub updates the appearance and/or position of the virtual object 460 in the shared state data in step 726 for each user sharing the virtual object 460. In particular, as discussed above, multiple users may share the same state data for shared virtual objects 460 to facilitate collaboration on a virtual object between multiple users. Where there is a single copy shared among multiple users, a change in appearance or position of the single copy is stored in the state data for the shared virtual object that is provided to each of the multiple users. Alternately, multiple users may have multiple copies of a shared virtual object 460. In this instance, a change in appearance of the shared virtual object may be stored in the state data for the shared virtual object that is provided to each of the multiple users.

However, a change in position may just be reflected in the copy of the shared virtual object that was moved, and not the others copies of the shared virtual object. In other words, a change in the position of one copy of the shared virtual object may not be reflected in other copies of the shared virtual object 460. In an alternative embodiment, where there are multiple copies of a shared virtual object, a change in one copy may be implemented across all copies of the shared virtual object 460 so that each maintains the same state data as to appearance and position.

Once the positions and appearances of virtual objects are set as described in FIG. 17, the hub 12 may transmit the determined information to the one or more processing units 4 in step 626 (FIG. 14). The information transmitted in step 626 includes transmission of the scene map to the processing units 4 of all users. The transmitted information may further include transmission of the determined FOV of each head mounted display device 2 to the processing units 4 of the respective head mounted display devices 2. The transmitted information may further include transmission of virtual object characteristics, including the determined position, orientation, shape and appearance.

The processing steps 600 through 626 are described above by way of example. It is understood that one or more of these steps may be omitted in further embodiments, the steps may be performed in differing order, or additional steps may be added. The processing steps 604 through 618 may be computationally expensive but the powerful hub 12 may perform these steps several times in a 60 Hertz frame. In further embodiments, one or more of the steps 604 through 618 may alternatively or additionally be performed by one or more of the processing units 4. Moreover, while FIG. 14 shows determination of various parameters, and then transmission of these parameters all at once in step 626, it is understood that determined parameters may be sent to the processing unit(s) 4 asynchronously as soon as they are determined.

The operation of the processing unit 4 and head mounted display device 2 will now be explained with reference to steps 630 through 658. The following description is of a single processing unit 4 and head mounted display device 2. However, the following description may apply to each processing unit 4 and display device 2 in the system.

As noted above, in an initial step 656, the head mounted display device 2 generates image and IMU data, which is sent to the hub 12 via the processing unit 4 in step 630. While the hub 12 is processing the image data, the processing unit 4 is also processing the image data, as well as performing steps in preparation for rendering an image.

In step 634, the processing unit 4 may cull the rendering operations so that just those virtual objects which could possibly appear within the final FOV of the head mounted display device 2 are rendered. The positions of other virtual objects may still be tracked, but they are not rendered. It is also conceivable that, in further embodiments, step 634 may be skipped altogether and the whole image is rendered.

The processing unit 4 may next perform a rendering setup step 638 where setup rendering operations are performed using the scene map and FOV received in step 626. Once virtual object data is received, the processing unit may perform rendering setup operations in step 638 for the virtual objects which are to be rendered in the FOV. The setup rendering operations in step 638 may include common rendering tasks associated with the virtual object(s) to be displayed in the final FOV. These rendering tasks may include for example, shadow map generation, lighting, and animation. In embodiments, the rendering setup step 638 may further include a compilation of likely draw information such as vertex buffers, textures and states for virtual objects to be displayed in the predicted final FOV.

Using the information received from the hub 12 in step 626, the processing unit 4 may next determine occlusions and shading in the user's FOV in step 644. In particular, the screen map has x, y and z positions of all objects in the scene, including moving and non-moving objects and the virtual objects. Knowing the location of a user and their line of sight to objects in the FOV, the processing unit 4 may then determine whether a virtual object partially or fully occludes the user's view of a real world object. Additionally, the processing unit 4 may determine whether a real world object partially or fully occludes the user's view of a virtual object. Occlusions are user-specific. A virtual object may block or be blocked in the view of a first user, but not a second user. Accordingly, occlusion determinations may be performed in the processing unit 4 of each user. However, it is understood that occlusion determinations may additionally or alternatively be performed by the hub 12.

In step 646, the GPU 322 of processing unit 4 may next render an image to be displayed to the user. Portions of the rendering operations may have already been performed in the rendering setup step 638 and periodically updated. Further details of step 646 are described U.S. Patent Publication No. 2012/0105473, entitled, “Low-Latency Fusing of Virtual And Real Content.”

In step 650, the processing unit 4 checks whether it is time to send a rendered image to the head mounted display device 2, or whether there is still time for further refinement of the image using more recent position feedback data from the hub 12 and/or head mounted display device 2. In a system using a 60 Hertz frame refresh rate, a single frame may be about 16 ms.

If it is time to display the frame in step 650, the composite image is sent to microdisplay 120. At this time, the control data for the opacity filter is also transmitted from processing unit 4 to head mounted display device 2 to control opacity filter 114. The head mounted display may then display the image to the user in step 658.

On the other hand, where it is not yet time to send a frame of image data to be displayed in step 650, the processing unit may loop back for more updated data to further refine the predictions of the final FOV and the final positions of objects in the FOV. In particular, if there is still time in step 650, the processing unit 4 may return to step 608 to get more recent sensor data from the hub 12, and may return to step 656 to get more recent sensor data from the head mounted display device 2.

The processing steps 630 through 652 are described above by way of example. It is understood that one or more of these steps may be omitted in further embodiments, the steps may be performed in differing order, or additional steps may be added.

Moreover, the flowchart of the processing unit steps in FIG. 14 shows all data from the hub 12 and head mounted display device 2 being cyclically provided to the processing unit 4 at the single step 634. However, it is understood that the processing unit 4 may receive data updates from the different sensors of the hub 12 and head mounted display device 2 asynchronously at different times. The head mounted display device 2 provides image data from cameras 112 and inertial data from IMU 132. Sampling of data from these sensors may occur at different rates and may be sent to the processing unit 4 at different times. Similarly, processed data from the hub 12 may be sent to the processing unit 4 at a time and with a periodicity that is different than data from both the cameras 112 and IMU 132. In general, the processing unit 4 may asynchronously receive updated data multiple times from the hub 12 and head mounted display device 2 during a frame. As the processing unit cycles through its steps, it uses the most recent data it has received when extrapolating the final predictions of FOV and object positions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A system for presenting a mixed reality experience, the system comprising:
a first display device including a display unit for displaying virtual objects including a shared virtual object and a private virtual object; and
a computing system operatively coupled to the first display device and a second display device, the computing system generating the shared and private virtual objects for display on the first display device, and the computing system generating the shared but not the private virtual object for display on a second display device.

2. The system of claim 1, wherein the shared virtual object and private virtual object are part of a single hybrid virtual object.

3. The system of claim 1, wherein the shared virtual object and private virtual object are separate virtual objects.

4. The system of claim 1, wherein interaction with the private virtual object affects a change in the shared virtual object.

5. The system of claim 4, wherein the change is a change in the content provided by the shared virtual object.

6. The system of claim 4, wherein the change is a change in the position of the shared virtual object.

7. The system of claim 4, wherein the change is a change in the appearance of the shared virtual object.

8. The system of claim 2, wherein the shared virtual object includes a virtual display slate having content displayed on the head mounted display device.

9. A system for presenting a mixed reality experience, the system comprising:
a first display device including a display unit for displaying virtual objects;
a second display device including a display unit for displaying virtual objects; and
a computing system operatively coupled to the first and second display devices, the computing system generating a shared virtual object for display on the first and second display devices from state data defining the shared virtual object, the computing system further generating a first private virtual object for display on the first display device and not the second display device, and a second private virtual object for display on the second display device and not the first display device, the computing system receiving an interaction changing the state data and the display of the shared virtual object on both the first and second display devices.

10. The system of claim 9, wherein the computing system displays the same shared virtual object to both the first and second display devices, upon changing the shared virtual object, from different perspectives of the first and second display devices.

11. The system of claim 10, wherein the interaction changes at least one of a position of the shared virtual object or content appearing as part of the shared virtual object.

12. The system of claim 9, wherein the interaction is an interaction with one of the first and second private virtual objects.

13. The system of claim 9, wherein the shared virtual object, the first private virtual object and the second private virtual object are part of a single hybrid virtual object.

14. The system of claim 9, wherein the shared virtual object, the first private virtual object and the second private virtual object are each separate virtual objects.

15. The system of claim 9, wherein the first private virtual object includes a first set of virtual objects for controlling interaction with the shared virtual object.

16. The system of claim 15, wherein the second private virtual object includes a second set of virtual objects for controlling interaction with the shared virtual object.

17. A method for presenting a mixed reality experience, the method comprising:
(a) displaying a shared virtual object to a first display device and a second display device, the shared virtual object defined by state data that is the same for the first and second display devices;
(b) displaying a first private virtual object to the first display device;
(c) displaying a second private virtual object to the second display device;
(d) receiving an interaction with one of the first and second private virtual objects; and
(e) affecting a change in the shared virtual object based on the interaction with one of the first and second private virtual objects received in said step (d).

18. The method of claim 17, further comprising the step (f) of receiving multiple interactions with the first and second private virtual objects, in addition to the interaction received in said step (d), to collaboratively change the shared virtual object.

19. The method of claim 17, wherein the step (f) of receiving multiple interactions with the first and second private virtual objects comprises receiving multiple interactions to collaboratively build, display or change an image.

20. The method of claim 17, wherein the step (f) of receiving multiple interactions with the first and second private virtual objects comprises receiving multiple interactions to collaboratively play a game.
